(19) United States
(12) Patent Application Publication
(10) Pub. No.: US 2026/0030458 A1
(43) Pub. Date: Jan. 29, 2026

(54) MANAGING AND DEPLOYING CUSTOMIZED ARTIFICIAL INTELLIGENCE CHATBOTS

(71) Applicant: MicroStrategy Incorporated, Vienna, VA (US)

(72) Inventors: Sergio Trejo-Rodriguez, Oakton, VA (US); Hao Shen, Fairfax, VA (US); Ji Jin, Vienna, VA (US); Aaron Nye, St. Augustine, FL (US); Jieqiong Jin, Vienna, VA (US); Jose Nocedal, Leesburg, VA (US); Yanjie Chen, HangZhou (CN); Zongkun Yue, Vienna, VA (US); Bo Hu, Vienna, VA (US); Ananya Ojha, Dunn Loring, VA (US); Jeffrey Clay Courcelle, Atkinson, NH (US)

(21) Appl. No.: 19/347,369

(22) Filed: Oct. 1, 2025

Related U.S. Application Data
(63) Continuation-in-part of application No. 18/596,738, filed on Mar. 6, 2024.
(60) Provisional application No. 63/703,111, filed on Oct. 3, 2024.

(51) Int. Cl. G06F 40/40; G06N 3/006

(52) U.S. Cl. CPC G06F 40/40; G06N 3/006

(57) ABSTRACT

Systems, methods, and apparatus, including computer-readable media, for managing and deploying customized artificial intelligence chatbots. In some implementations, a system receives data indicating user input instructing a chatbot to be created and an indication of a data set for the chatbot to use. The system creates the chatbot based on data objects in the data set. The system provides a code segment or module configured to cause a chatbot interface for interacting with the chatbot to be embedded in a user interface. The system receives a user prompt provided for the chatbot through the user interface. The system provides a response to the user prompt from the chatbot, and the response from the chatbot includes text generated by one or more artificial intelligence and/or machine learning (AI/ML) models using values from the data set.

### CROSS-REFERENCE TO RELATED APPLICATIONS

This application is a continuation-in-part (CIP) of U.S. patent application Ser. No. 18/596,738, filed on Mar. 6, 2024, and this application claims the benefit of priority to U.S. Provisional Patent Application No. 63/703,111, filed on Oct. 3, 2024, and the entire contents of the previous applications are hereby incorporated by reference herein.

### BACKGROUND

The present specification relates to techniques for customizing applications, interfaces, and modules that leverage artificial intelligence and machine learning.

Artificial intelligence (AI) and machine learning (ML) techniques have improved significantly and continue to gain new capabilities. For example, neural network models, such as large language models, have shown the capability to process and to generate many types of natural language text. For example, chatbots that leverage large language models can respond to user prompts (e.g., user inputs such as questions) in text-based messaging sessions or conversations with users. Training the most capable models typically requires a very large amount of training data as well as large amounts of computing power and time. Many users use generalized models that are highly trained and highly capable, but are limited to default behavior and cannot be customized for particular uses or contexts.

### SUMMARY

In some implementations, a computer system provides functionality for creating and distributing customized interactive applications, such as chatbots, that provide responses using artificial intelligence or machine learning (AI/ML) models, such as large language models (LLMs). For example, the computer system can provide an interface through which a user, such as an administrator, can create or edit an interactive application. The computer system can provide an initial base application or template that includes the core functionality that enables users to obtain content from an AI/ML model. The administrator can use the interface customizations that alter the appearance and behavior of the interactive application, so the customized application provided to users will operate as the administrator intends. The customizations can include, for example, specifying the data sources available to be used in responding to user prompts (e.g., questions or statements input to a chatbot), as well as whether information from the Internet or other external sources can be used in generating responses. The interface also allows the administrator to set user access control and usage limits for the interactive application, to control resource consumption and costs incurred by repeated inference processing using AI/ML models.

After the administrator customizes the interactive application using the interface, the computer system saves the interactive application (e.g., as a new or updated chatbot) and makes the application available to other users. For example, the computer system can send hyperlinks or invitation messages to users, so the users can access a customized chatbot through a web page or web application. As another example, the computer system can include code to integrate the customized chatbot into an existing web page or web application (e.g., as an embedded item, in an iFrame, etc.). As another example, the computer system can integrate with document libraries, file browsers, document viewers, web browsers, or other types of user interfaces. As a result, the customized chatbot can be made available through any of various enterprise software platforms and applications. The interface of the customized chatbot can then be invoked by interacting with an icon or menu item for the customized chatbot, or by entering a user prompt into a text entry field of a user interface. In some implementations, the interface of the chatbot can be provided together with a document viewer, for example, in a sidebar or tab shown concurrently with the document viewer interface. This arrangement can enable the user to view a document, such as a dashboard related to a dataset, while concurrently having a conversation with a customized chatbot designed to answer questions about the dataset.

The computer system enables interactive applications to be tailored or targeted for specific data sets. For example, each interactive application that is created or customized can provide responses with information derived from a corresponding data set specified by the administrator, such as a private data set (e.g., a database table, a data cube, a spreadsheet, etc.). The system enables administrators to create and deploy multiple interactive applications concurrently. For example, different chatbots that have different behavior tailored for different sets of users. Similarly, different chatbots can be configured to provide data from different source data sets. Administrators can create and deploy different instances of chatbots and other interactive applications, each with customized behavior, appearance, and other characteristics as appropriate for their respective data sets and users.

The computer system enables administrators to customize AI/ML-enabled chatbots very quickly, without the need to re-train an AI/ML model. In particular, after specifying the customizations for the chatbot, no model training is needed and so the customized chatbot can be used right away. The system can provide a preview interface or test interface that enables an administrator to change chatbot settings and try out the updated chatbot in the generation or editing interface, to see the effects of changes in real time or near real time. To facilitate customizability and the rapid generation of chatbots, the customizations to the chatbot can be made outside the training state of the AI/ML chatbot itself, for example through the selection of which existing AI/ML model(s) to be used, which dataset(s) being used, which portions of a dataset are accessible, and the parameters or characteristics of interactions with the AI/ML model(s). Customizations can also be implemented in operations of a non-AI/ML processing system, for functions such as access control, precision or granularity of data access, and so on. With the ability to provide customized chatbots without the need to train or re-train AI/ML models, the system allows rapid generation and deployment of chatbots with minimal up-front computing resources and no training delay.

The computer system can support interactive applications where processing tasks for responding to a user prompt are split between non-AI/ML or non-probabilistic data processing systems (e.g., database management systems) and AI/ML models. For example, when a user prompt such as a natural language query is received, the computer system can use a database system to generate a set of result data that is relevant to the user prompt. The set of result data can then be processed using one or more AI/ML models, such as a large language model, to generate content to present in a response to the user. This system can combine the strengths of AI/ML models and non-AI/ML processing systems to provide a chatbot or other application with responses that are more complete, accurate, and reliable than either type of processing system on its own.

In general, many AI/ML models have excellent generative capabilities and the ability to produce high-quality natural language output. However, AI/ML models also often have significant limits. For example, AI/ML models typically use probabilistic processing, which may generate responses that are generalized or approximate, and so may not adequately answer a user's question or may lack the accuracy or precision needed. In some cases, AI/ML models provide content that includes hallucinations or other information that may be statistically plausible given training data but is actually factually incorrect. The probabilistic nature of AI/ML models can also result in the same user prompt resulting in significantly different responses at different times, which can decrease users' confidence and ability to rely on the responses. For example, the same question may yield different numerical answers when the question is asked multiple times to an AI/ML model, even when the source data set has not changed.

As discussed further below, the computer system can provide chatbots and other interactive applications that combine the advantages of AI/ML models and the reliability and accuracy of other non-AI/ML or non-probabilistic data processing systems, such as relational database systems. Database management systems and other systems can reliably provide result data that is accurate and reliable, calculated from the source data using proven and validated processes. For example, data processing systems can be used to search a data set and make calculations, perform aggregations, and generate values in a data series in a repeatable or deterministic manner. This can be done even over large data sets, which may be much larger than an AI/ML system can accept as input context. In addition, the processing can be focused on the specific data set of interest, without extraneous data influencing the calculations as might occur in the probabilistic processing of an AI/ML model trained on large quantities of other data.

When the interactive application is used to respond to a user prompt, the non-AI/ML data processing system (e.g., a database management system) generates result data relevant to the user prompt (e.g., user's question) from the source data set. The user prompt and the result data set, potentially with other information and context, can be provided to the AI/ML model to generate text output for the response to the user. For example, the computer system can send a request for the AI/ML model to summarize the result data set or to generate a response to the original user prompt from the result data set that has been generated. As a result, the text that the AI/ML model generates can draw from values calculated accurately from the source data set, without requiring the AI/ML model to be capable of generating those values itself or without the AI/ML model even accessing the data set. As a result, the output to the user combines the reliable, accurate calculations from the non-AI/ML system with the text and other information provided by the AI/ML model from the result data set.

Combining the processing of AI/ML systems and non-AI/ML systems in the chatbots enhances privacy by limiting the amount of data that the AI/ML model or any other third parties receive. This can provide users with higher confidence in using the system, as well as allow the use of a wider range of third-party AI/ML service providers. When processing queries relating to a data set, the AI/ML model does not need to receive the full contents of the underlying dataset that the chatbot is based on. Indeed, in many cases, the AI/ML model does not receive even portions of the actual dataset, and instead receives only metadata describing the general contents and/or structure of the data set (e.g., types of metrics and attributes, semantic meaning of the columns, etc.) and potentially sample data (e.g., fictitious examples that illustrate the type of content in the dataset without revealing the actual values and records). In addition to enhancing privacy, this also increases speed and reduces network transfer requirements, since the dataset does not need to be sent over a network and the dataset itself does not need to be processed by the AI/ML model. The process also allows the data processing system (e.g., an enterprise database management system) to reliably apply security policies and access control over the dataset that the AI/ML model typically would not be capable of applying. After the data processing system performs processing to generate a result data set, the AI/ML model is provided the result data set and asked to generate a summary. In this interaction, the AI/ML model receives the result data set that generally includes aggregated or composite information specifically answering the user's question, and the AI/ML model does not receive access to the underlying dataset itself. As a result, the system avoids granting the AI/ML model—and any third-party providing the AI/ML model as a service—access to portions of the dataset that are not appropriate for answering the current question.

The customizations that the administrator set in creating or customizing the chatbot can be used to alter the operation and results of the non-AI/ML data processing system, the AI/ML model, the front-end interface that the user sees, or a combination of any or all of them. For example, the customizations that the administrator selects can specify which dataset(s) to use when answering questions, whether additional public datasets or the Internet can be used to answer questions, which portions (e.g., columns, rows, data types, etc.) of datasets can be accessed, and so on. In addition, the customizations that the administrator selects can specify output characteristics for the chatbot such as the style, formatting, media type (e.g., text, images, text and images, etc.), and other properties of answers.

In some implementations, the customized chatbots can be configured to generate visualizations in response to questions and other user prompts. These visualizations can also be generated through a combination of processing by AI/ML models and non-AI/ML processing systems. For example, if a user prompt requests a visualization or if a visualization is otherwise appropriate for a response, the AI/ML model can specify the type of visualization (e.g., bar chart, line graph, pie chart, etc.) and other properties (e.g., data series shown, scale and data on the axes, etc.). The actual values to be displayed in the visualization, however, can be calculated by the non-AI/ML processing system, using reliable and accurate calculations from the data set. As a result, the AI/ML system can design and format a visualization appropriate to answer the user prompt, while the actual data populating the visualization is not subject to the uncertainties of AI/ML processing.

In general, splitting response generation among multiple processing systems, e.g., an AI/ML model and a database management system, increases the quality of output and control over the process of generating responses. The arrangement also facilitates customizability by allowing administrators to select different AI/ML models and different AI/ML service providers to customize their chatbots. With the system performing discrete operations leveraging AI/ML models, separate from the core querying of an enterprise's proprietary datasets, the chatbots can be more easily integrated with the processing capabilities of third-party systems.

In one general aspect, a method performed by one or more computers includes: providing, by the one or more computers, an interface for creating or editing an interactive application configured to provide responses generated using one or more artificial intelligence (AI) or machine learning models; receiving, by the one or more computers, customization data through the interface, wherein the customization data indicates customizations specified by a user to customize the interactive application, wherein the customization data identifies a data set for the interactive application and specifies one or more characteristics of behavior of the interactive application; storing, by the one or more computers, one or more records specifying configuration settings representing the customizations for the interactive application; and providing, by the one or more computers, access to the interactive application with the customizations for one or more users, such that the interactive application is configured to generate a response to a user prompt using (i) a result determined from the data set based at least in part on the user prompt and (ii) content generated by the one or more AI or machine learning models from processing the result determined from the data set.

In some implementations, the interactive application comprises a chatbot, and the one or more AI or machine learning models comprises a large language model.

In some implementations, providing the interface comprises providing data for a user interface of a web page or web application.

In some implementations, providing the interface comprises providing an application programming interface.

In some implementations, providing the interface comprises providing user interface data for a user interface comprising (i) a set of interactive elements to that are selectable by a user to change settings of the interactive application, and (ii) a region for interacting with the interactive application, including an input control configured to submit user prompts and an output area configured to provide responses of the interactive application to the user prompts.

In some implementations, the interface includes one or more controls to alter an appearance of the interactive application; the customization data indicates customizations specified by the user that include changes to the appearance of the interactive application; and the stored one or more records indicate the changes to the appearance of the interactive application.

In some implementations, the interface includes one or more controls to alter one or more messages to provide to users of the interactive application; the customization data indicates customizations specified by the user that include the one or more messages; and the stored one or more records indicate the one or more messages to provide to users of the interactive application.

In some implementations, the interface includes one or more controls to set whether the interactive application can use information from the Internet to respond to user prompts; the customization data indicates customizations specified by the user that include a setting whether the interactive application can use information from the Internet to respond to user prompts; and the stored one or more records indicate the setting whether interactive application can use information from the Internet to respond to user prompts.

In some implementations, the interface includes one or more controls to control access to the interactive application by users; the customization data indicates customizations specified by the user that adjusts which users can access the interactive application; and the stored one or more records indicate criteria specifying which users can access the interactive application.

In some implementations, the interface includes one or more controls to limit an amount of usage of the interactive application by users; the customization data indicates customizations specified by the user that set a limit on the amount of usage of the interactive application by users; and the stored one or more records indicate the limit on the amount of usage of the interactive application by users.

In some implementations, the interface includes one or more controls to limit the portions of the data set that can be used to generate responses provided by the interactive application; the customization data indicates customizations specified by the user that specify a subset of the data set to be used by the interactive application to generate responses; and the stored one or more records indicate the subset of the data set to be used by the interactive application to generate responses.

In some implementations, the interactive application is configured to vary which portions of the data set are used to provide responses by the interactive application to different users based on respective permissions or access levels of the different users.

In some implementations, the one or more AI or machine learning models comprises a third-party AI or machine learning model; and the interactive application is configured to generate responses to user prompts based on (i) generating results to the user prompts from the data set using a data processing system, and (ii) providing the generated results to the third-party AI or machine learning model, so that the third-party AI or machine learning model generates content for the responses without direct access to the data set.

In some implementations, the result comprises result data generated by a database management system based on a query or set of processing operations determined using the user prompt; and the interactive application is configured to obtain the content from the one or more AI or machine learning models by requesting that the one or more AI or machine learning models summarize results from the database system.

In some implementations, the interactive application is configured to generate a response to a user prompt by performing operations including: sending a first request to the one or more AI or machine learning models based on the user prompt, wherein the first request requests instructions for analyzing the data set based on the user prompt; causing data processing instructions that the one or more AI or machine learning models generated in response to the first request to be carried out using deterministic processing of a data processing system separate from the AI or machine learning models; sending a second request to the one or more AI or machine learning models, including results generated by carrying out the data processing instructions and a request to generate text based on the results; and providing, in a response to the user prompt, text that the one or more AI or machine learning models generated in response to the second request.

In some implementations, the first request is a request for instructions specified in code of a programming language; and wherein causing the data processing instructions to be carried out comprises causing the instructions specified by the code of the programming language to be performed.

In some implementations, the interactive application is configured to respond to at least some user prompts with data for a visualization of data from the data set, wherein the interactive application is configured to request and receive data describing characteristics of the visualization from the one or more AI or machine learning models.

In some implementations, the visualization comprises a chart or graph of a type of data indicated by the one or more AI or machine learning models based on information from a user prompt, with the chart or graph depicting values for the type of data wherein the values are determined by a database system separate from the one or more AI or machine learning models.

In another general aspect, a method performed by one or more computers includes: receiving, by one or more computers, a user prompt provided to an interactive application; accessing, by one or more computers, configuration data that indicates a data set or data source for the interactive application to use in answering user prompts; sending, by one or more computers, a first request to one or more artificial intelligence and/or machine learning (AI/ML) models based on the user prompt, wherein the first request is for the one or more AI/ML models to generate data processing instructions to obtain data to answer the user prompt from the data set or data source; generating, by one or more computers, result data from the data set or data source based on the data processing instructions generated by one or more AI/ML models; sending, by one or more computers, a second request to one or more AI/ML models and providing at least a portion of the result data to one or more AI/ML models, wherein the second request is for the one or more AI/ML models to generate a response to the user prompt based on the generated result data from the data set or data source; and providing, by one or more computers, a response to the user prompt that includes text that the one or more AI/ML models generated in response to the second request.

In another general aspect, a method performed by one or more computers includes: providing, by the one or more computers, an interface to receive a user input to an interactive application that is configured to provide responses generated using one or more artificial intelligence or machine learning (AI/ML) models, wherein the interactive application is associated with a data set; receiving, by the one or more computers, a user prompt through the interface, the user prompt comprising natural language text; in response to receiving the user prompt, obtaining, by the one or more computers, code or instructions generated using the one or more AI/ML models, wherein the code or instructions are configured to cause a data processing system to retrieve data that is relevant to the user prompt from the data set; obtaining, by the one or more computers, result data generated from the data set as a result of processing the code or instructions using a data processing system; obtaining, by the one or more computers, natural language text generated by the one or more AI/ML models based on the result data generated from the data set; and providing, by the one or more computers, a response to the user prompt through the interface, wherein the response is based on the natural language text generated by the one or more AI/ML models based on the result data.

In some implementations, obtaining the code or instructions comprises providing a first request to the one or more AI/ML models, wherein the first request requests code or instructions specifying data processing criteria to retrieve or generate result data to answer the user prompt; and obtaining the natural language text generated by the one or more AI/ML models comprises providing a second request to the one or more AI/ML models, wherein the second request provides the result data and requests an answer to the user prompt.

In some implementations, providing the first request comprises providing the first request to a third-party AI/ML service provider; the data processing system is separate from the third-party AI/ML service provider; providing the second request comprises providing the second request to the third-party AI/ML service provider, wherein the second request includes result data;

and, to generate the response to the user prompt, the third-party AI/ML service provider does not receive access to content of the data set other than to receive the result data.

In some implementations, the method includes: in response to receiving the user prompt, selecting from one or more knowledge bases, knowledge base content that is determined to be relevant to the user prompt; and providing the selected knowledge base content with the first request or the second request.

In some implementations, obtaining the code or instructions generated using the one or more AI/ML models comprises: generating a request to the one or more AI/ML models that includes (i) an instruction to generate code or instructions to retrieve data from the data set based on the user prompt, and (ii) a data model or data schema that indicates logical objects of the data set; and receiving output that the one or more AI/ML models generated, including code or instructions that specify data processing criteria expressed using references to one or more of the logical objects from among the logical objects of the data set that are indicated by the data model or data schema.

In some implementations, the logical objects comprise metrics or attributes available from the data set; and the code or instructions refer to one or more of the metrics or attributes using a name or identifier specified in the data model or data schema for the one or more of the metrics or attributes.

In some implementations, the code or instructions generated by the one or more AI/ML models specify one or more operations that express one or more criteria specified in natural language in the user prompt and are configured to retrieve, filter, sort, rank, or aggregate data from the data set.

In some implementations, the code or instructions comprise a structured query language (SQL) statement generated by the one or more AI/ML models.

In some implementations, the request includes content from one or more knowledge bases that specify a set of definitions or descriptions of terms for an organization, wherein the one or more knowledge bases are updated separately from the one or more AI/ML models.

In some implementations, the interactive application is a chatbot, and wherein the method includes initializing a session of the chatbot including providing content of the one or more knowledge bases to the one or more AI/ML models such that the content of the one or more knowledge bases is used as context for responding to the user prompt.

In some implementations, the content of the one or more knowledge bases is shared across multiple chatbots, such that updates to the one or more knowledge bases update the knowledge available to each of the multiple chatbots for interpreting user prompts.

In some implementations, obtaining the result data generated from the data set as a result of processing the code or instructions using a data processing system comprises processing the code or instructions using a database system.

In some implementations, obtaining the natural language text generated by the one or more AI/ML models based on the result data generated from the data set comprises: providing a request to the one or more AI/ML models to answer the user prompt based on the result data, wherein the request includes (i) the user prompt and (ii) the result data.

In some implementations, the interactive application comprises a chatbot; and the one or more AI/ML models comprise a large language model.

In some implementations, providing the interface comprises providing data for a user interface of a web page or web application.

In some implementations, providing the interface comprises providing an application programming interface.

In some implementations, the interactive application is configured to vary which portions of the data set are used to provide responses by the interactive application to different users based on respective permissions or access levels of the different users.

In some implementations, the method includes: generating visualization data for a visualization of the result data; and providing the visualization data in the response to the user prompt.

Other embodiments of these aspects include corresponding systems, apparatus, and computer programs, configured to perform the actions of the methods, encoded on computer storage devices. A system of one or more computers can be so configured by virtue of software, firmware, hardware, or a combination of them installed on the system that in operation cause the system to perform the actions. One or more computer programs can be so configured by virtue having instructions that, when executed by data processing apparatus, cause the apparatus to perform the actions.

The details of one or more embodiments of the invention are set forth in the accompanying drawings and the description below. Other features and advantages of the invention will become apparent from the description, the drawings, and the claims.

### BRIEF DESCRIPTION OF THE DRAWINGS

FIGS. 1A and 1B are diagrams showing an example of a system for creating, distributing, and using customized chatbots.

FIGS. 2 to 13 are user interface diagrams illustrating examples of creating, distributing, and using customized chatbots.

FIGS. 14A-14C show how the system enables a customized chatbot to be accessed through any of multiple different interfaces.

Like reference numbers and designations in the various drawings indicate like elements.

### DETAILED DESCRIPTION

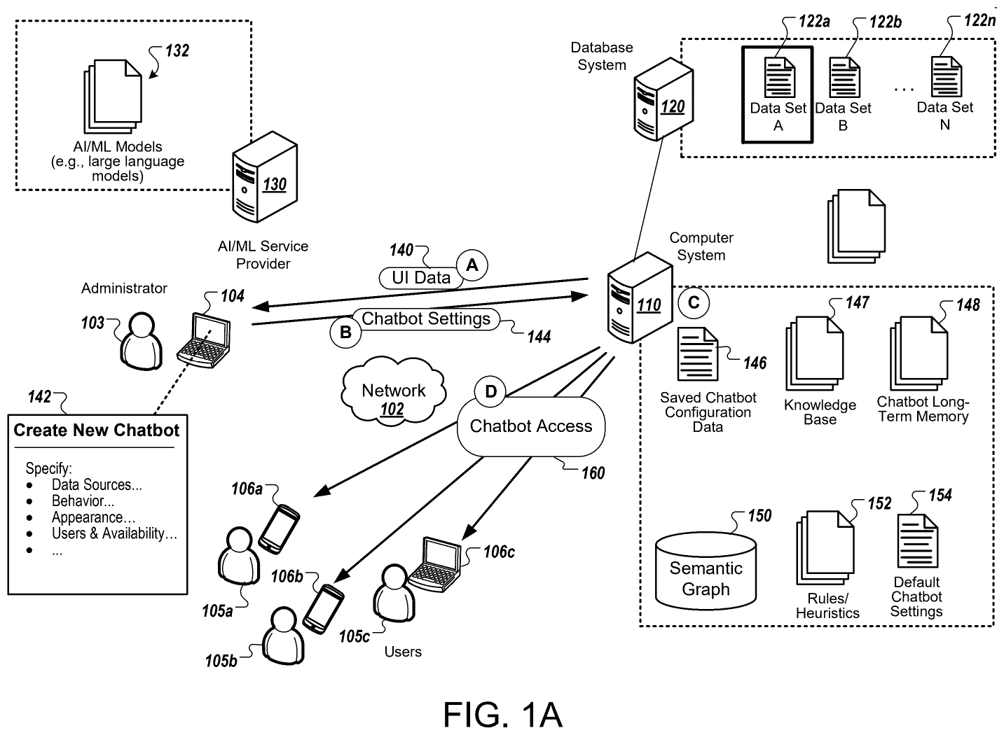

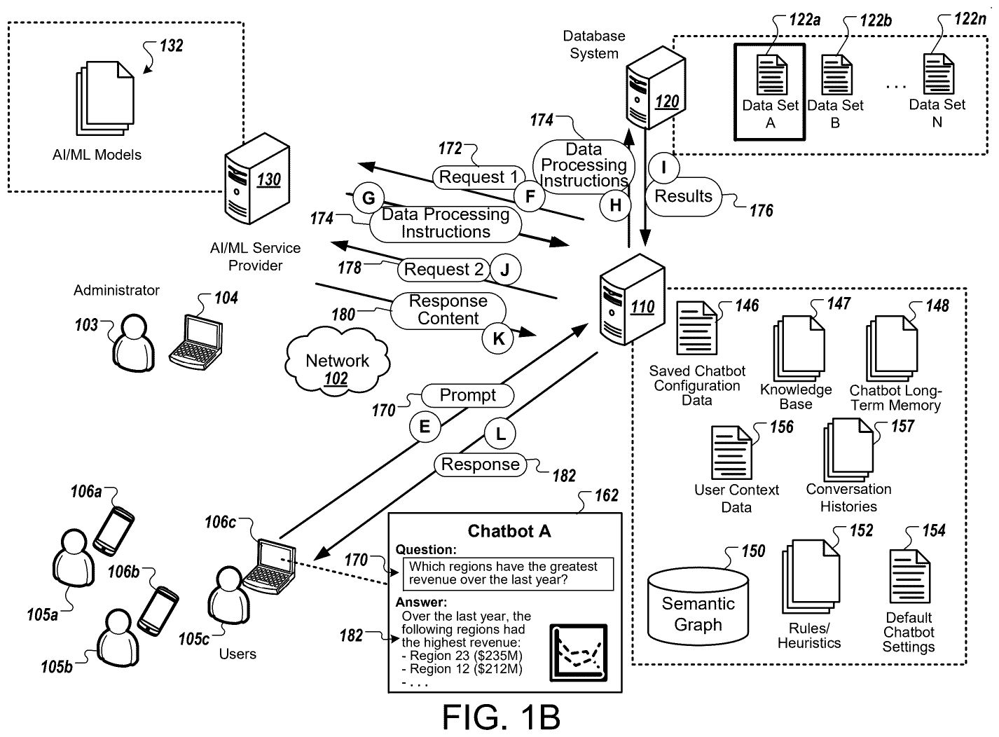

FIGS. 1A-1B are diagrams showing an example of a system 100 for creating, distributing, and using interactive applications such as customized chatbots. The system 100 includes a computer system 110, a database system 120, and a AI/ML service provider 130. The elements of the system 100 communicate over a network 102, such as the Internet. The computer system 110 coordinates a variety of functions for creating and operating chatbots. For example, the computer system 110 interacts with a client device 104 of an administrator 103 to receive customization data that indicates customizations for a chatbot. The computer system 110 then provides access to the customized chatbot to client devices 106a-106c of other users 105a-105c, and the computer system 110 coordinates processing to generate and provide answers to questions and other user prompts provided to the customized chatbot.

The example of FIGS. 1A-1B includes stages (A) to (L), which represent various operations and a flow of data, and which can occur in the order illustrated or in a different order. In FIG. 1A, stages (A) to (D) show an example of creation of a customized chatbot and access being provided to users. In FIG. 1B, stages (E) to (L) show an example of the customized chatbot being used, from issuance of a question or prompt 170 from a user to display of a response 182 from the customized chatbot.

The computer system 110 can be implemented using one or more servers, including one or more cloud computing systems. For example, the computer system 110 can be an application server. The computer system 110 provides front-end functionality to interface with various client devices. For example, the computer system 110 can provide an interface for creating and editing chatbots and other interactive applications that leverage AI/ML models. The interface can be an application programming interface (API), a user interface (e.g., by providing user interface data for a web page or web application), or another type of interface. As discussed further below, the computer system 110 performs various other functions to generate and save customized chatbots, to manage and grant access to existing chatbots, and to coordinate the processing of user prompts to generate responses from the chatbots.

The database system 120 can provide various data retrieval and processing functions. For example, the database system 120 can be a database management system (DBMS), and can include the capability to process operations specified in structured query language (SQL), Python code, or in other forms. The database system 120 has access to various datasets 122a-122n, which can be private datasets for organization, such as a company. The database system 120 can store and use datasets in any of various forms such as tables, data cubes, or other forms.

The AI/ML service provider 130 can be a server system or cloud computing platform that provides access to one or more AI/ML models 132, such as LLMs. The computer system 110, the database system 120, and the AI/ML service provider 130 may be implemented as separate systems or may be integrated in a single system. For example, the AI/ML service provider 130 can be a third-party service or can be managed and operated by the same party as the computer system 110 and/or the database system 120.

As an overview, to create a customized chatbot, the administrator 103 interacts with the computer system 110 to specify the features and behavior that are desired for the chatbot. Through a series interactions, the administrator 103 can specify characteristics such as which dataset(s) 122a-122n the chatbot will use to generate responses, the appearance and style of the chatbot interface, whether the chatbot can access data from the Internet or other sources, access control settings, and so on. The computer system 110 saves the settings specified by the administrator 103 and creates a new chatbot.

To provide the interface, the computer system 110 can provide data for a web application, web page, or native application that, when rendered on a client device, provides the functionality to specify settings of the chatbot being created or edited.

In stage (A), the computer system 110 provides user interface data 140 to the client device 104 over the network 102. For example, the computer system 110 can provide content of a web page or web application for creating or editing the customized chatbot. The user interface data 140 is rendered on the display of the client device 104, represented by user interface 142.

The user interface 142 provides controls to specify many different properties of the chatbot. For example, the user interface 142 enables the administrator 103 to specify the data source or dataset that the chatbot will draw from to provide responses. The user interface 142 also allows the administrator 103 to specify various aspects of the behavior of the chatbot, including suggestions, instructions to the user, and more. The user interface 142 also includes controls for the administrator 103 to specify characteristics of the appearance of the chatbot, including color schemes, layout, formatting, size, and other characteristics. The user interface 142 also includes controls for the administrator 103 to specify access control, such as to specify which users can access the chatbot, the number or frequency of questions users are permitted issue to the chatbot, the platforms or interfaces in which the chatbot is available, and so on.

In stage (B), the administrator 103 uses the interface 142 to enter the settings that customize the appearance and operation of the chatbot. The client device 104 sends the specified settings 144 to the computer system 110 over the network 102.

As an example, the administrator 103 selects a particular dataset 122a as the data source for the chatbot, as a result, the chatbot will generate responses based on the information in this dataset 122a. In some implementations, each chatbot is focused on a specific dataset or collection of records. This can allow the chatbot to be tailored closely to a specific application, task, purpose, or set of users or roles in an organization. In addition, limiting the scope of data that the chatbot can access can improve accuracy in responses by limiting the amount of extraneous information that might otherwise be introduced. In addition, focusing a chatbot on a specific dataset can increase performance and reduce response times, by reducing the complexity and amount of data that needs to be processed to generate answers.

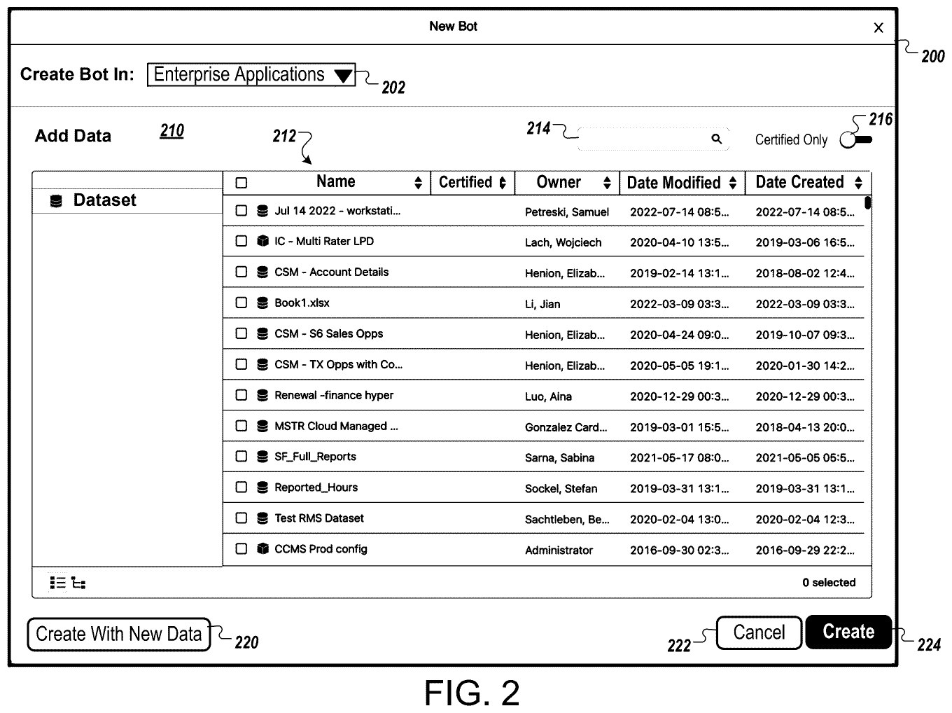

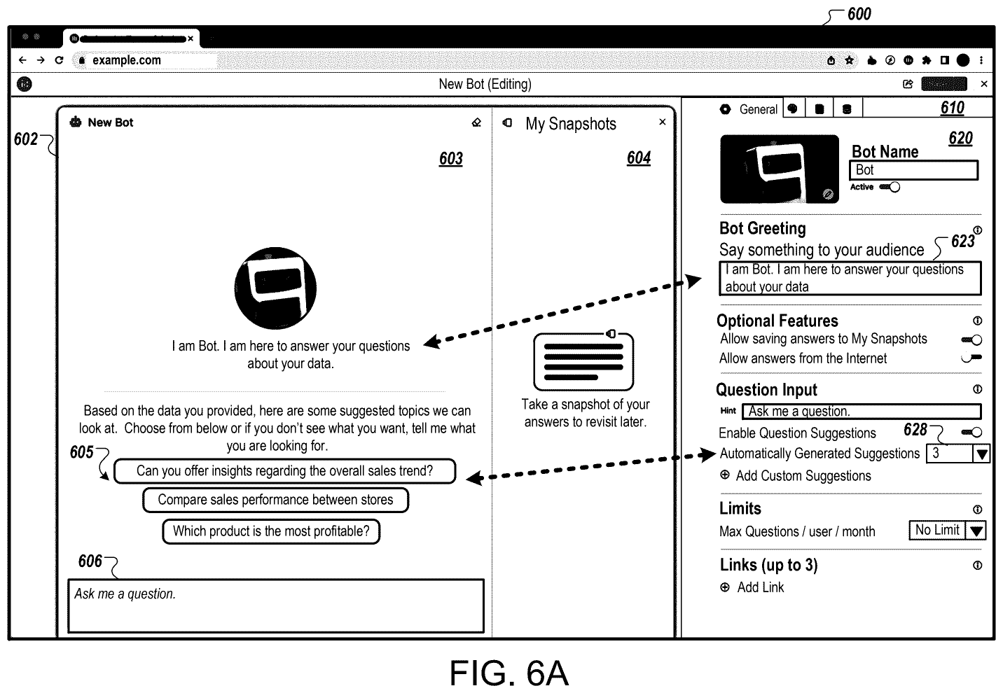

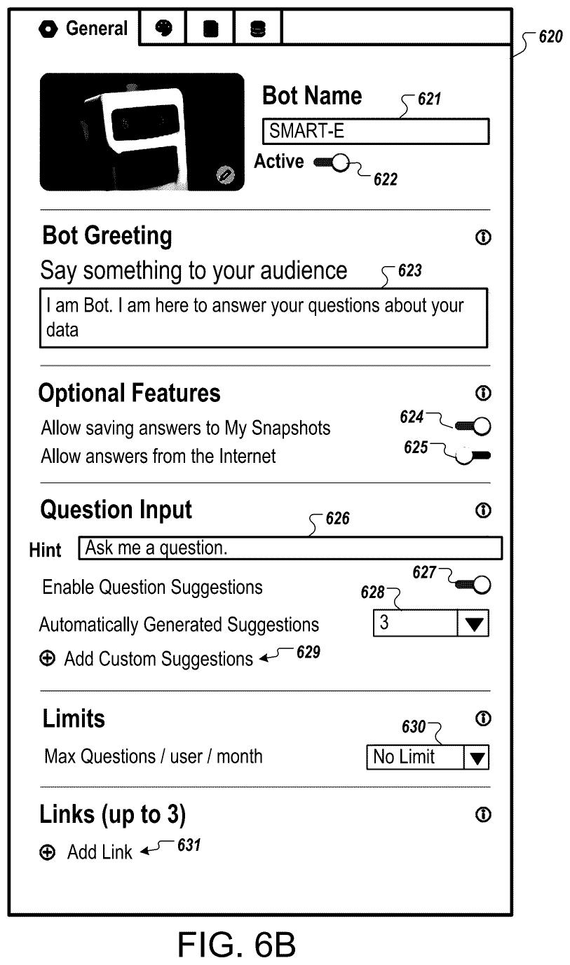

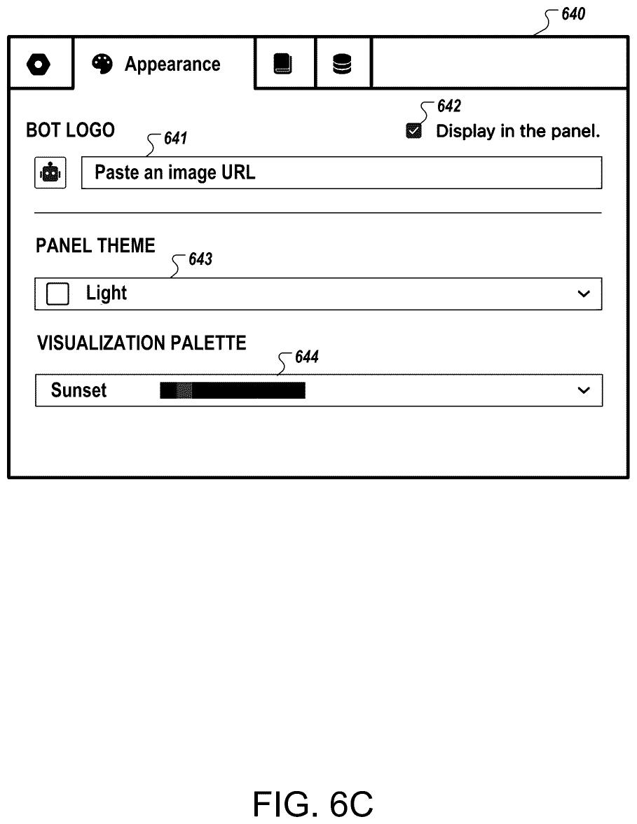

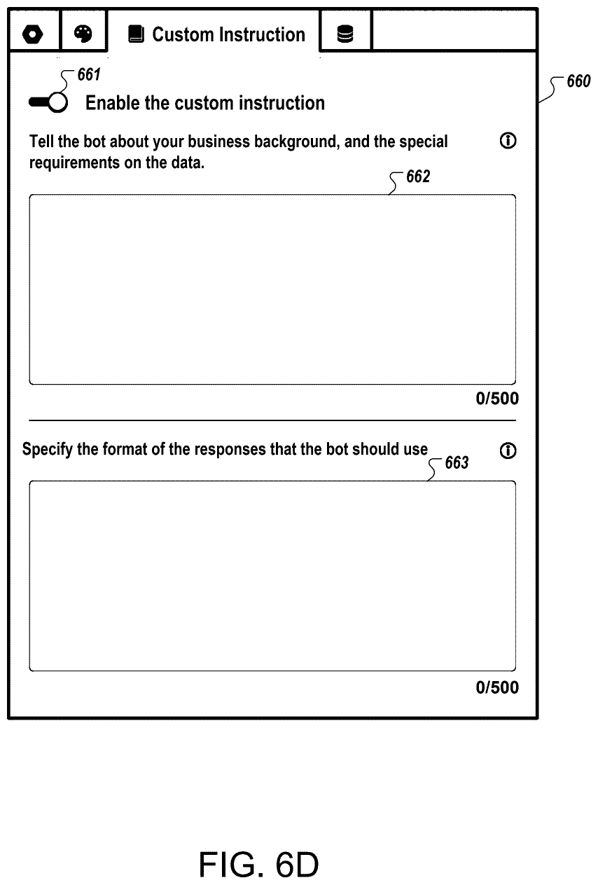

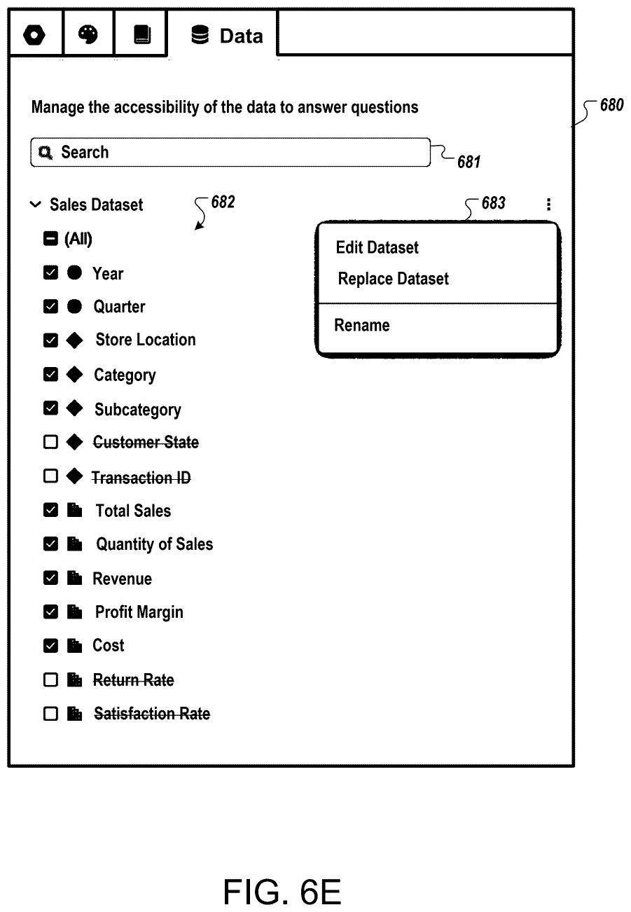

The process of specifying the settings for the chatbot can be iterative, with potentially multiple rounds of the administrator 103 interacting with the user interface 142 to incrementally adjust and test the settings of the chatbot. For example, as discussed below for FIG. 6A, the user interface 142 can provide a preview area or test panel in which the chatbot can run and provide interactions with the administrator 103 during the process of specifying the customized chatbot settings 144. As the administrator 103 makes changes to the chatbot settings, the administrator 103 can issue questions to the chatbot and evaluate the responses and interaction behavior with the newly updated settings, allowing the administrator 103 to make further changes based on the results experienced. FIGS. 2-6E, discussed further below, show examples of the user interface 142 and further illustrate the types of settings that can be adjusted to customize the chatbot.

Referring still to FIG. 1A, in stage (C), the computer system 110 uses the customized chatbot settings 144 from the administrator 103 to generate and save the data and settings that define the chatbot. In the example, this is shown as saved chatbot configuration data 146. For example, the computer system 110 can create a record or series of records representing the new chatbot and its customized settings. For each chatbot, the computer system 110 saves a separate set of records or definitions that specify the characteristics and customizations of that chatbot. For example, each chatbot can have a set of saved chatbot configuration data 146 that specifies, among other items, the name of the chatbot, the dataset for the chatbot, a selection of which AI/ML models 132 to use for the chatbot, the appearance and formatting characteristics of the chatbot, access control information for the chatbot, customized instructions to append to or include in user prompts to AI/ML models, and so on.

The computer system 110 can include a number of modules and datasets that facilitate the generation of new chatbots. For example, the computer system 110 can include a set of default chatbot settings 154 that provides a default or base configuration for new chatbots. The customizations specified in the received chatbot settings 144 can override or replace settings in the default set of chatbot settings 154 to form the final set of saved chatbot configuration data 146.

Generating and saving the chatbot can include registering the chatbot with a number of different applications, web pages, web applications, or other services. For example, the computer system 110 can register the new chatbot, with its name, capabilities, and applicable context, so that the option for the chatbot appears for users who have been granted access. For example, the chatbot can be made available through the document libraries of users who are approved to access the chatbot.

In some implementations, the computer system 110 enables the administrator 103 to attach one or more additional data sets to adjust the operation and output of the chatbot. For example, an additional data set can be a knowledge base 147 or data dictionary can be added. Unlike the primary data set that the user selects for the chatbot (e.g., data set 122a), the chatbot is not configured to answer questions about the additional data set or to retrieve metrics or to provide visualizations of the knowledge base 147. Instead, the knowledge base 147 can be provided to assist the chatbot in interpreting user queries and providing responses with the terminology for the user's organization. In general, the knowledge base 147 can function to provide contextual knowledge to the AI/ML models 132, so the models can classify and use the nomenclature of the end user when generating answers to user prompts.

Many different organizations or departments use terms that have a special contextual meaning, or are not part of general language, and so would not be available for training of an LLM. For example, a company may internally use various names for its products, projects, teams, locations, policies, initiatives, organizational structure, and so on. For example, a company be developing a product with a codename of “starfish” that being developed by a group of employees called “red team.” The training state of an LLM would not incorporate information about these entities, which are specific to the company and not referenced in public documents. To enable the chatbot to process questions about these internal entities and provide answers that reference them, a knowledge base 147 is designated for the chatbot to describe these and other internal terms. Each time the user submits a prompt, the knowledge base 147 can be provided to assist the LLM with the context that is appropriate for the company. The knowledge base 147 can provide information similar to a semantic graph, by describing entities and their relationships. In some cases, the information in the knowledge base 147 can be derived from a semantic graph 150 and then converted into text (e.g., unstructured, semi-structured, or structured) in a format that can be processed by the LLM.

In general, the knowledge base 147 or other additional data set can include data that maps terms or phrases to their meanings. In many cases, this can include semi-structured data or explanatory content, as a way to explain entities and relationships wo the AI/ML models 132. Although the knowledge base 147 may include definitions, more generally the information may include descriptions of people, roles, business units, products, and other terms that may be referenced. The administrator 103 may upload one or more of additional data sets and specify which additional data sets, if any, should be used to provided context for a chatbot. The data sets selected for this contextual function can then be used to provide context for all prompts and responses of the chatbot.

In some implementations, the contextual data sets or knowledge bases can be applied so that they apply to multiple chatbots. For example, an enterprise can designate one or more knowledge bases 147 as contextual data sets that can be applied consistently across the enterprise, for all chatbots created and used in the enterprise. Similarly, different departments within the enterprise may add their own particular contextual data sets that may supplement the enterprise-wide knowledge bases 147. In addition, specific contextual data sets can be added for specific chatbots. In this way, chatbots at different levels of an organization can inherit a consistent set of terminology and knowledge in an organization, which also makes maintaining the overall knowledge base much more simple. The knowledge bases 147 can additionally or alternatively be specified with a scope that corresponds to a computing environment, so that chatbots associated with a particular domain or server inherit the knowledge bases for that domain or server.

One of the advantages of the knowledge base 147 is consistency for many users and even for many different chatbots of an organization. The user submitting a prompt does not need to take any action to select or include the knowledge base 147 in the chatbot's processing, the chatbot automatically include the knowledge base 147 in its context for each prompt or question received. Also, because the knowledge base 147 can be shared or inherited by many chatbots within an organization, updating and maintaining the knowledge base 147 is simple. An edit to the knowledge base 147 is automatically applied to all of the chatbots associated with the organization, even if the chatbots were created by different administrators or provided to different sets of users.

In addition, the knowledge base 147 provides persistent context that is not lost from one prompt to another or from one session to another. The knowledge base content can also be implemented applied in a manner that the knowledge base 147 does not count toward the instruction token limits that the AI/ML models 132 consume for each response. Rather than counting toward the tokens for prompts and recent history, the knowledge base 147 can be accessed or provided to the AI/ML models 132 as a separate source of knowledge apart from the prompt and context, and so does not count toward the token limits of an LLM. Implementations of access to the knowledge base 147 can vary. For example, when a session with the chatbot is instantiated, the knowledge base can be provided as part of initializing the chatbot. In some cases, the AI/ML models 132 are additionally or alternatively configured to access the primary dataset and if the user prompt includes a term or makes a request for an item not specified in the primary dataset, the chatbot is configured for the AI/ML models 132 to then check the knowledge base or other contextual data sets. In some implementations, the knowledge base 147 can be prepared as an embedding, a vector database, or other format that can be accessed by or referred to by the AI/ML models 132.

With the additional knowledge chatbot has three general sources of information before even receiving the user prompt. First, the chatbot has the primary dataset (e.g., data set A 122a) selected by the administrator 103, which is the primary source of answer for the chatbot. Second, the chatbot has a set of instructions that the administrator 103 provided, e.g., general instructions such as the description of the primary dataset, the purpose of the chatbot, the type of user or type of task interacting with the chatbot, and a description of how the chatbot should form responses (e.g., response format, types of data to include, order of elements to include, etc.). Third, the chatbot has the knowledge base, which provides additional context behind the purpose of the chatbot and how the customer defines things. These types of information form a base level of information that is available for all users that use the chatbot. Also, for each user, the chatbot receives the user's prompt and also receives information about the conversation history of the user (e.g., previous queries and responses, from the current session and/or prior sessions).

In some implementations, the chatbot is designed to have a long-term memory 148, which can store information learned from users in past interactions. For example, LLMs and other AI/ML models 132, on their own, are generally stateless and do not natively understand the user context or history of interactions with the user, especially from previous sessions. The computer system 110 can facilitate learning by the chatbot to provide infrastructure that creates a long-term memory 148 for the chatbot. For example, the long-term memory 148 can store items such as definitions of terms for a particular user context, unique text elements the chatbot might encounter, and feedback from prior user interactions.

One valuable aspect of the long-term memory 148 is the ability for the chatbot to learn and adapt from explicit or implicit user feedback over time. If a user asks questions, then gives feedback they were expecting something different (e.g., either through text of a prompt to the chatbot or through an external survey or rating), then the computer system 110 can capture that feedback and update the chatbot to better provide what the user intended in the future. For example, the computer system 110 may add or adjust the instructions to the chatbot to reflect the user expectations or preferences. In some cases, this may include changing the default response format or response instructions, or may include adding rules or explanations that are context-dependent (e.g., apply to specific phrases or prompt types). This learning may occur at different levels. For example, it may include learning that particular terms, phrases, or combinations of terms call for a particular type of response. As another example, the feedback may more shift answers generally in certain ways, e.g., to be more verbose, more concise, to add or change visualizations, to change the order of content, to add or adjust summary elements, and so on.

The learning of the chatbot is managed by the computer system 110 and happens on an ongoing basis as users interact with the chatbot. The information learned is stored outside the LLM or other AI/ML models 132, and is stored in the long-term memory 148 designated for the chatbot. Each chatbot that is created can have its own long-term memory 148, which is updated by the interactions of its own users. Before the computer system 110 asks the stateless LLM to provide a response to a user prompt, the computer system 110 facilitates retrieval of data from the long-term memory 148, potentially to provide customized instructions or additional contextual data to accompany the user prompt and tailor the response based on what has been learned from prior interactions. The long-term memory 148 thus provides better reference data for LLM to use in guiding answer generation.

The long-term memory 148 can include business definitions of other users have specified or uploaded. In this way, the long-term memory 148 can supplement or expand on the descriptions provided in the knowledge base 147. The chatbots can be configured to learn at different levels, e.g., at the level of individual users, at the level of a department or group of users, and for an enterprise as a whole. In other words, the preferences of an individual may be learned and applied for that individual. In addition, the aggregate preferences learned for many individuals can be combined to also adjust the chatbot, to accelerate the adaptation of the chatbot to meet the needs of the user base. In some implementations, the computer system 110 can use access control lists and permissions for users to apply security policies to adjust access and appropriately set the context for each user.

In stage (D), the computer system 110 provides access to the chatbot to various users. 105a-105c. For example, the chatbot settings 144 specified by the administrator 103 can specify access control parameters that indicate groups of users or individual users or categories of users who receive access to the new chatbot. The computer system 110 provides access to the chatbot to authorized users in any of various ways. For example, the computer system 110 can send a message to authorize users with a URL or other link to web page, web application, or native application functionality providing the chatbot interface. As another example, the computer system 110 can update and interface such as a document library, dashboard, or other user interface to include a panel with the chatbot interface, or to include an icon, button, or other control that is interactive so that users can interact to request that the chatbot interface be provided.

Referring to FIG. 1B, after the chatbot has been customized and saved, a user 105c interacts with the chatbot. For example, the user 105c accesses a user interface 162 for the chatbot. The user interface 162 includes a field in which the user can enter a question or other user prompt 170. In the example, the user 105c enters the prompt 170, and the user's client device 106c sends the prompt 170 to the computer system 110 for processing. The computer system 110 receives the prompt 170 and begins a series of interactions used to generate the response to the prompt 170.

As discussed above, the chatbot has an associated knowledge base 147 that can include, for example, descriptions of terms that may have a unique meaning in the particular context of the user. The knowledge base 147 may be shared by multiple chatbots or even all chatbots associated with the company or organization of the user. When the computer system 110 establishes a new session of the chatbot and a user, the computer system 110 can provide the knowledge base 147 as part of initializing the session with the AI/ML model 132. As a result, the knowledge base 147 can provide additional context for all of the subsequent interactions with the AI/ML model 132.

In addition, the chatbot has information in its long-term memory 148 that has been learned through previous interactions with users. This information can be provided upon initialization of the chatbot, as the knowledge base 147 is, or can be provided in other ways. For example, the information from the long-term memory 148 can be selectively and contextually applied, as the computer system 110 analyzes the prompt 170 and determines whether there is information in the long-term memory 148 that is relevant to the content of the prompt 170. The retrieved content of the long-term memory 148 that the computer-system 148 determined to be relevant to the prompt, can then be provided with the prompt 170. As another example, certain information in the long-term memory 148 may be applicable to a specific user, role, or permission level, and the computer system 110 can provide that information in response to determining that the user 105c submitting the prompt 170 is that user or has that role or permission level. In other cases, the information in the long-term memory 148 supplements or alters the general instructions or initialization commands for starting the chatbot session, either in all cases or selectively when specific prompt content or user context is detected.

In stage (F), the computer system 110 generates and sends a first request 172 to the AI/ML service provider 130. The first request 172 includes the prompt 170 and information about the dataset 122a, and represents a request for an AI/ML model 132 to generate instructions for answering the prompt 170. For example, rather than asking the AI/ML model 132 for the answer to the prompt 170, the first request 172 can request a SQL statement, programming code, a list of operations, or other instructions that specify how to retrieve or calculate and answer to the prompt 170. As a simple example, the prompt to the LLM in the first request 172 may include an instruction such as “provide a SQL statement that retrieves the data needed to answer the question <<user prompt>>,” or “generate Python code that can run on <<database system>> to calculate the answer to the question <<user prompt>>.” The content of the first request 172 can be designed for the particular AI/ML model 132 and its capabilities.

As a result, the first request 172 can be a request for a SQL statement or Python code that, when interpreted or executed by another system such as the database system 120, will cause the other system to retrieve and/or generate a focused subset of data (e.g., a result data set) from the data set 122a that can be used to answer to the prompt 170 from the dataset 122a. The first request 172 can also include one or more custom instructions that the administrator 103 specified, to further orient the AI/ML model 132 to generate data processing instructions that are most applicable for the tasks, situations, purposes, or users that the chatbot is designed for. In some cases, one or more custom instructions are appended or otherwise included with the user prompt 170 in the first request 172.

Many AI/ML models 132, such as LLMs, operate in a substantially stateless manner, in which a general model 132 does not automatically include context of previous interactions or specific knowledge about the chatbot being used. In addition, the chatbots provided by the computer system 110 do not need to have a one-to-one relationship with the AI/ML models 132. For example, a single model 132 may serve as the model for many different customized chatbots that are created and hosted using the computer system 110. Creating and customizing a chatbot does not require training or updating an AI/ML model 132, and instead can define parameters of the chatbot experience that are separate from the AI/ML model 132 (e.g., LLM) itself (e.g., parameters such as the data set used, the custom instructions provided with user prompts, whether Internet data can be used, the format and preferences for answers, and so on).

In order for the AI/ML model 132 to be able to appropriately answer the first request 172 and provide data processing instructions to answer the prompt 170, the computer system 110 can include with the request 172 information about the dataset 122a and the database system 120. For example, the first request 172 can include metadata about the structure and contents of the dataset 122a, without including actual data of the dataset 122a. For example, the metadata may include a database schema, a description of the dataset structure, a description of semantic, meaning of the tables, columns, and other elements of the dataset, and so on. The request 172 may also include sample data, such as a few rows of data or fictitious computer-synthesized data that is of the same type and structure as the dataset 122a, but does not include the actual values from the dataset 122a.

For example, the first request 172 can indicate the types of data in the dataset 122a, and include a sample row or rows of data from the dataset 122a. The request 172 can also include information about the capabilities of the database system 120 and the data processing functions and manipulations that are available. For example, the request 172 can include instructions or description how to interact with the database system 120 to perform various processing functions, such as commands for sorting, filtering, joining, and otherwise manipulating data. In some cases, this information may include text of a user manual or other human-readable text describing the use of the database system 120. As another example, the request 172 can include a table of available commands for manipulating data in the database system 120, an API description for the database system 120, a list of valid interactions and their effects, or other data.

The first request 172 can be generated or adjusted based on information in the long-term memory 148 or other information about the user. For example, given the user interactions or feedback received through prompt-response cycles with the user 105c and/or other users, the long-term memory 148 may include information that can clarify what users intend when they ask a question as indicated in the prompt 170. For example, the long-term memory may specify that a visualization should be included, or that data should be ordered in a particular way. In addition, the computer system 110 also stores information about the user 105c and his current context, represented as user context data 156. This user context data 156 can indicate, for example, the identity of the user, permissions of the user, a device type of the user's device 106c, a location of the user, a role of the user, a department of the user, and so on. In addition, the computer system 110 stores conversation histories 157 of users that have previously interacted with the chatbot. As a result, information about previous prompts from the user 105c and previous responses, in whole or in part (e.g., in summary form) and from the current session and/or previous sessions, can be retrieved and used to supplement the prompt 170. The computer system 110 can provide the user context data 156 and conversation history 157 for the user 105c in or with the request 172, so the AI/ML model 132 can generate data processing instructions with the context of the user's situation and previous conversations, which may better explain or help disambiguate the most recent prompt 170.

In stage (G), the AI/ML service provider 130 uses the AI/ML models 132 to generate a response to the first request 172. The AI/ML service provider 130 then sends the response, a set of data processing instructions 174, to the computer system 110. As discussed above, the first request 172 requests instructions specifying the processing operations that the database system 120 can use to retrieve and/or generate (e.g., calculate) from the dataset 122 the result data that would be needed to answer the user prompt 170. As a result, the AI/ML service provider 130 uses the AI/ML models 132 to generate the data processing instructions 174 that, when executed by the database system 120, will retrieve and/or generate the data needed to answer the prompt 170. In this process, the system 100 leverages the ability of the AI/ML models 132, e.g., LLMs, to generate a set or sequence of instructions or operations. The data processing instructions 174 can be expressed in any of a variety of ways, such as one or more SQL statements, as executable or interpretable code, such as Python code, as a list of API calls or commands to be executed, and so on.

In stage (H), the computer system 110 uses the received data processing instructions 174 to instruct the database system 120 to obtain (e.g., retrieve, calculate, generate, etc.) the data needed to answer the user prompt 170. For example, the computer system 110 may send a request that includes the data processing instructions 174 to the database system 120, in order to request the needed data. In some implementations, the computer system 110 may apply a set of rules or validation checks to verify that the data processing instructions 174 are valid and appropriate to be executed by the database system 120. For example, the computer system 110 can store rules or heuristics 152 that can evaluate the data processing instructions 174 element by element and/or as a whole to verify and correct the data processing instructions 174 if needed before they are sent to the database system 120. In some implementations, the computer system 110 uses the rules or heuristics 152 to convert or transform the data processing instructions 174 from one format or type to another.

When interacting with the AI/ML service provider 130 and/or the database system 120, the computer system 110 can apply the customized settings and properties that the administrator 103 defined for the chatbot. For example, the administrator 103 can limit which portions of the dataset 122a can be accessed by the chatbot, and so the computer system 110 can apply those limits so that the first request 172 to the AI/ML service provider 130 does not reference omitted data (e.g., excluding from the description of the data set 122a columns or tables that are not to be referenced, so the AI/ML models 132 cannot use them or even determine that they exist). Similarly the first request 172 can include instructions to specifically exclude or avoid using certain data. In addition, or as an alternative, the computer system 110 can filter, edit, or otherwise check the data processing instructions 174 so that the operations specified do not draw from or become calculated based on excluded data. In addition, or as an alternative, the computer system 110 can analyze the results 176 to verify that the results 176 do not include or are not based on the excluded data.

As another example, the computer system 110 can apply access control policies or custom behavior based on the identity or role of the user 105c issuing the prompt 170. Those custom behaviors can be reflected in the interactions of the computer system 110 to the AI/ML service provider 130, such as in the request 172, as well as in the interactions with the database system 120.

In stage (I), the database system 120 generates and sends results 176 that include the data retrieved from and/or generated based on applying the data processing instructions 174 for the dataset 122a. The database system 120 processes or executes the data processing instructions 174 that it receives, which creates the results 176, which may be in any of various forms, such as records retrieved, data series, aggregations of data, statistics about data in the dataset 122a, subsets of the dataset 122a determined to be relevant, and so on.

In the illustrated example, the user prompt 170 asks which regions have the greatest revenue over the last year. The data processing instructions 174 generated by the AI/ML models 132 specify the operations needed to generate measures of revenue by region for the previous year. For example, the data processing instructions 174 may include a SQL statement to retrieve these values, or may include a set of instructions in a programming language, such as Python. The results 176 generated by the database system 120 include the values needed to answer the question in the user prompt 170. In other words, the results 176 include values of revenue for the regions specified in the dataset 122a, appropriately labeled or associated with identifiers for those regions. In this process, the AI/ML models 132 have been leveraged to obtain the results 176, however, the AI/ML models 132 did not need or receive access to the dataset 122a itself, and the AI/ML models 132 did not incur the resource costs of having to process the dataset 122a. In addition, the database system 120 and its reliable, repeatable calculations ensure that the results 176 are accurate, without the AI/ML models 132 introducing uncertainty into the calculations.

In addition, the dataset 122a may be very large, much larger than the maximum context length of an LLM used for the AI/ML model 132. In many cases, the amount of data in the dataset 122a may be orders of magnitude larger than the maximum context size that the LLM can process. The database system 120 can process a large dataset much more quickly and with greater power efficiency than an LLM can. Due to limits on LLM context sizes, it may be impractical or impossible for an LLM to analyze the dataset 122a to generate the needed results 176.

In stage (J), the computer system 110 sends a second request 178 to the AI/ML service provider 130. The second request 178 includes the results 176 and requests that the AI/ML models 132 generate a summary or other text response that answers the prompt 170 based on the results 176. For example, the second request 178 may be a request to answer the prompt 170 using the data in the results 176 as context. As another example, the second request 178 may be a request for the AI/ML models 132 to summarize the results 176, in addition to or instead of answering the user prompt 170. The second request 178 can also include one or more custom instructions that the administrator 103 specified, to further orient the AI/ML model 132 to respond in the format and with the content that is most applicable for the dataset 122a and/or the overall purpose for which the chatbot was designed (e.g., customization for a particular organization, set of users or user roles, set of tasks, etc.). In some cases, one or more custom instructions are appended or otherwise included with the user prompt 170 in the second request 178.

As with the first request 172, the computer system 110 can provide the user context data 156 and conversation history 157 for the user 105c in or with the second request 178, so the AI/ML model 132 can generate a response based on the context of the user's situation and the user's previous conversations, which may better explain or help disambiguate the most recent prompt 170. The computer system 110 can also provide information from the long-term memory 148 that the computer system 110 determines to be relevant, potentially as determined to be relevant specifically to the user 105c, the user context data 156, and/or the prompt 170.

In some implementations, the chatbot is configured to generate visualizations as part of the response to a user prompt 170. To create these visualizations, the computer system 110 can include in the second request 178, or as an additional request, a request for the AI/ML models 132 to indicate an appropriate type and format of visualization for the response to the request 178. The AI/ML models 132 can then be used to specify the parameters for the visualization, such as the type of visualization (e.g., line chart, bar chart, line graph, geographical map, heat map, etc.), and identification of which data items are shown on different axes or dimensions of the visualization, the ranges to show, the labels to use, the color scheme, and or other properties.

In stage (K), the AI/ML service provider 130 uses the AI/ML models 132 to generate response content 180 for the user prompt 170, e.g., an answer to the user prompt 170, which can include a summary of the results 176 or other response requested by the second request 178. For example, the second request 178 may include or provide access to the results 176 and the user prompt 170, and so the AI/ML models 132 answer the prompt 170 based on the information provided by the results 176 and potentially other context information (e.g., previous interactions in the conversation or session, information shown on a user interface of the client device 106c, etc.). In some implementations, the response content 180 may be a summary of or description of the results 176 and/or may include values extracted from the results 176 with added text description generated by the AI/ML models 132.

For example, in the illustrated example, the AI/ML models 132 indicate the specific regions having the greatest revenue, as requested by the prompt 170, along with an indication of the revenue values taken from the results 176, along with other description and contacts. If the request 178 requests information about a visualization, or if the AI/ML models 132 determine that a visualization is likely appropriate or beneficial, then the response content 180 can include a visualization description. The visualization description can specify the properties recommended for a visualization of the results 176 as a whole, or for specific items that answer the user prompt 170.

In stage (L), the computer system processes the response content 180, and generates and sends a response 182 as the answer of the chatbot to the user prompt 170. The response 182 is then displayed on the user interface 162 of the client device 106c. The computer system 110 can process the response content 180 to create the response 182, for example, by applying customized settings or policies specified in the saved chatbot configuration data 146. In this way, the computer system 110 can apply customized style, formatting, content preferences or restrictions, and other customizations that were defined by the administrator 103. In addition, or as an alternative, the computer system 110 can incorporate those customizations when making the request once of the eight. For example, the computer system 110 may include in the request 178 preferences for a concise or verbose answer, the tone or style of text used, and other preferences.

When a visualization is requested by the prompt 170 or suggested by the AI/ML models 132, the computer system 110 uses the visualization description from the AI/ML models 132 to generate the actual visualization content. In this manner, the visualization that is provided is based on reliable, accurate data or calculations in the results 176 and/or the dataset 122a. For example, the visualization that is rendered has the type of data specified by the AI/ML model 132, and in the arrangement specified by the AI/ML models 132, but with values or data series shown being determined through data retrieval and/or calculations of the database system 120 to ensure accuracy and reliability.

Through any and all of the interactions of the computer system 110 to generate and provide the response 182, the computer system 110 applies the settings and properties specified in the saved chatbot configuration data 146. As a result, the behavior and characteristics that the administrator 103 specified for the chatbot can be enforced at any or all stages of the process to provide the customized interface and chatbot behavior that the administrator 103 desired.

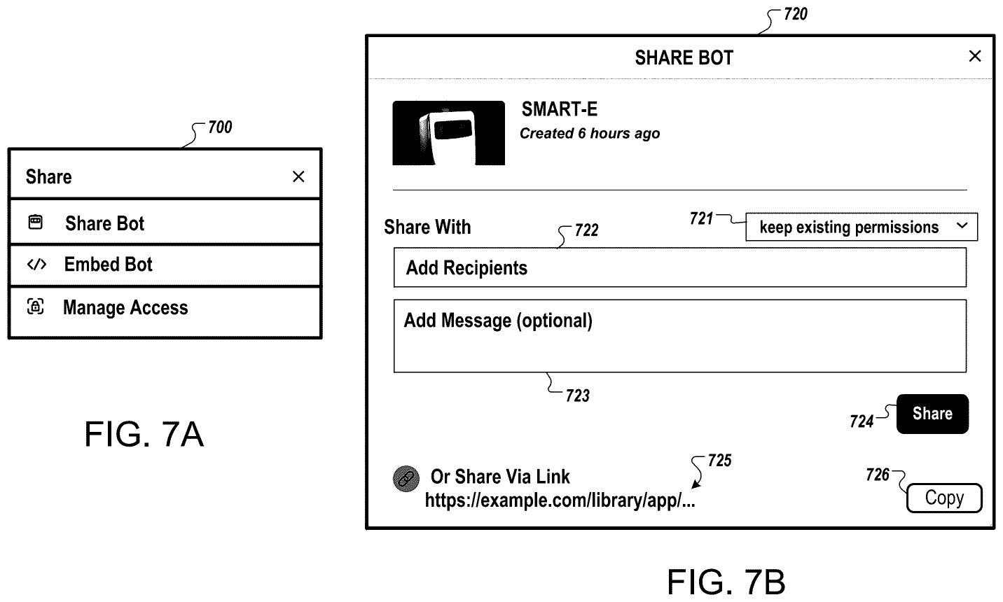

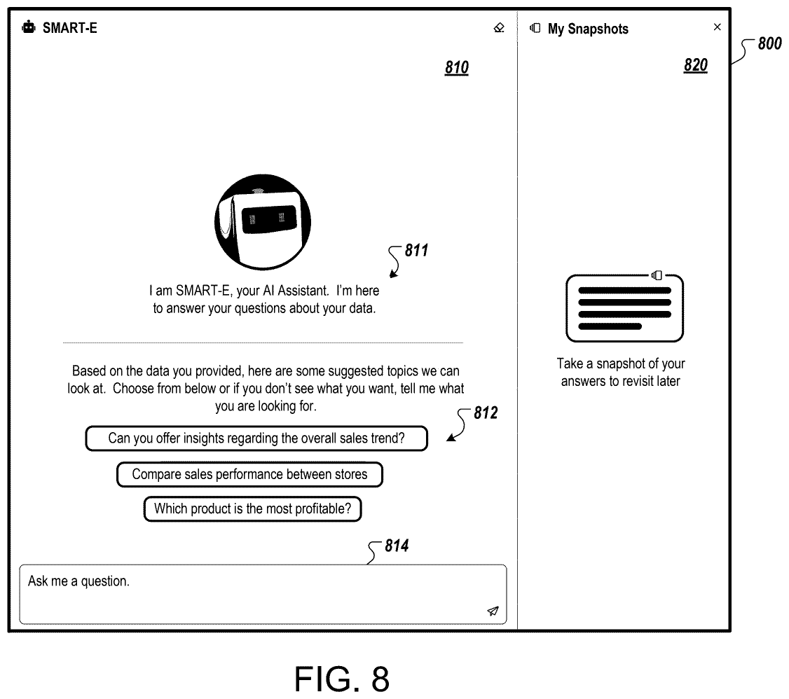

FIGS. 2-13 illustrate various user interfaces for creating, sharing, deploying, and using chatbots. FIGS. 2-6E show interfaces that the administrator 103 can use to create or edit a chatbot with customized characteristics and behavior. FIG. 7A-7B illustrate interfaces for sharing a customized chatbot. FIG. 8 shows an example of a user interface for interacting with the customized chatbot.

The computer system can provide users a simple and streamlined process for creating a chatbot that is hosted by the computer system 110. For example, after a user has an account established, the user can upload data for the chatbot through any of various methods, such as to drag-and-drop a file (e.g., a spreadsheet, database file, etc.), provide a link or identifier for a file or data set in a cloud computing account, or use a cloud computing connector to access data sets in any of various cloud computing platforms. The system then prepares and ingests the data, including identifying logical objects (e.g., attributes, metrics, etc.). The user can then edit the new chatbot with features as shown in FIGS. 2-10, then save the chatbot, share it, and send invitations through any of various communication platforms (e.g., email, text messaging, etc.). The process can be performed entirely through a web-based or cloud-computing-hosted environment. This allows the system to create and distribute the chatbot very quickly, often in minutes. Once the chatbot is created and configured, the administrator can embed the chatbot into any of various existing systems, including mobile device applications, desktop computer applications, web pages, web applications, and so on.

The system can provide administrators tools and interfaces configured to perform a variety of functions in managing chatbots. For example, the interface can provide features to certify the a chatbot, view chatbots and status of each (e.g., active, disabled, etc.), view and edit access control lists, track activity, view statistics (e.g., who is using the chatbot, error rates, trends, amount of executions, etc.).

For example, the management interface provided to an administrator can include the ability to stop or disable a chatbot. This can be a simple setting to make the chatbot available or not. The management interface can also provide features to limit use, such as to impose limits or quotas on the number of prompts each user or group of users can submit over period of time.

The management interface can include features to improve the management of chatbots generally. For example, in addition to the ability specify chatbot-specific settings for each chatbot individually, the management interface can include features to specify universal settings that apply to all chatbots or a collection of multiple chatbots. For example, the system can define chatbots as a type of object or application, and then store and enforce a set of parameters that applies to all objects of the chatbot type. This can allow settings at a high level to provide consistency across a set of multiple chatbots, including by automatically applying the settings to new chatbots that will be generated in the future. In some implementations, the universal settings can supersede settings made for individual chatbots. In other implementations, at least some of the universal settings can act as a default or initial setting which the individual settings of a chatbot can override.

In some implementations, the management interface enables the administrator to create a chatbot based on an existing source object in a library, such as a data set 122a-122n, a document (e.g., a dashboard, a report, etc.), and so on. The computer system 110 can then create a chatbot that inherits properties of the source object, such as access control lists, permissions and restrictions, and so on. The provides a very fast way for an administrator to create a chatbot, by importing the data set or data source characteristics as well as other settings from an existing object.

In some implementations, settings for chatbots can be defined for user types or user groups. For example, a company may have three categories of users, e.g., business users, executives, and research scientists. The company may have multiple different chatbots, each targeted to different topics or data sets. In general, the company may not want to impose a cap or limit on chatbot usage by the research scientists, because they need the access to develop new products and algorithms. However, for business users, the company may want to impose a limit, such as no more than 20 chatbot questions per day to limit costs, and the company may block custom chatbots from accessing and using information from the Internet. For the executives, the company may intend for the chatbots to be as fully featured as possible. To achieve these variations in functionality for different categories of users, the system can apply broadly-applicable or universal settings across the multiple chatbots of the company to impose constraints selectively according to user type or user role. This is much more efficient for the administrator and for the computer system 110 than having to create, store, and manage separate versions of each chatbot for each user type. To support this, the computer system 110 can allow different roles to be defined or designated to have different privileges. Privileges and access for a chatbot can be specified at any of various levels, e.g., for individual users, for user groups, for user roles, or universally for all users.

FIG. 2 shows an example of a user interface 200 that the administrator 103 can use to create a new chatbot or other AI/ML-powered interactive application. The interface 200 includes a control 202 for the administrator 103 to select an environment or category in which the new chatbot will be made available. The user interface 200 also includes a data selection area 210 that includes a variety of controls enabling the administrator 103 to specify the dataset(s) that the new chatbot can access and use. In some implementations, the chatbot is based on a single dataset or collection of datasets that is specified in advance when the chatbot is created. In many cases, it is helpful for administrators to create separate chatbots based on different datasets and to customize the appearance and behavior of each chatbot specifically for the set of users or type of tasks that the chatbot will be used with.

In some implementations, the administrator 103 creates a chatbot to answer questions about a specific set of data, such as a specific spreadsheet or data collection that is static and unchanging, e.g., a fixed set of data. In other implementations, however, the dataset(s) specified may grow and change and be updated over time, and the chatbot will interact and provide data based on the most recent contents or state of those datasets. The database system 120 and the new customized chatbot will be able to take advantage of new and updated data in the selected dataset, using the most recent, up-to-date contents each time a new user prompt is submitted. In other words, selecting a dataset can specify the data source that the chatbot will look to for generating responses and answers to user prompts, but the answers the chatbot provides in the future can be based on the contents of the dataset at the time of the request.

This can allow the chatbot to avoid issue of “knowledge cutoff,” where an LLM does not incorporate any information about events or facts after its training is complete, and the issue of limited context size, both of which are significant limitations for many LLMs. Typically, an LLM only has information about, and can only answer based on, information observed through training or provided as context (e.g., in or with a user prompt, or prior history in the conversation). As discussed above, the size allowed for context is limited and the training state is fixed at some point in time and cannot include more recently generated information. Nevertheless, in the present system, the database system 120 can generate results 176 based on current, up-to-date data in the dataset 122a, without the AI/ML models 132 needing to be trained on that data or enter that data as context. The results 176 can then be entered as context for the second request 178, which limits the amount of context that the AI/ML model 132 needs to process (e.g., the results 176, not the full dataset 122a or sections of the dataset 122a).

Referring still to FIG. 2, the data selection area 210 includes a table 212 showing a list of datasets that are available to the administrator 103. For example, the table 212 shows a number of files, data cubes, data tables, or other data collections listed by name. The table 212 also indicates other properties of the datasets, such as whether the dataset is certified, who the owner or creator of the dataset is, a date of the most recent modification, and a creation date. The data selection area 210 includes controls, such as checkboxes, that the administrator 103 can interact with to select one or more datasets for the new customized chatbot being created.

The interface 200 also includes a button 220 that, when selected, allows the administrator 103 to create a chatbot with new data, such as by importing or creating a new dataset, rather than using one of the existing datasets from the table 212 as the basis for a chatbot. The interface 200 also includes a control 224 to initiate creation of the chatbot based on the selected datasets. The interface 200 also includes a cancellation control to 222 that will cancel the chatbot creation process if selected.

To assist the administrator 103 in finding the desired datasets, the interface 200 includes a search field 214 that the administrator can enter a keyword or query in to search among the existing datasets available to the administrator 103. The interface 200 can also include a variety of filter controls for narrowing the set of datasets shown, such as a control 216 that can be selected to limit the datasets shown to those that have been certified.

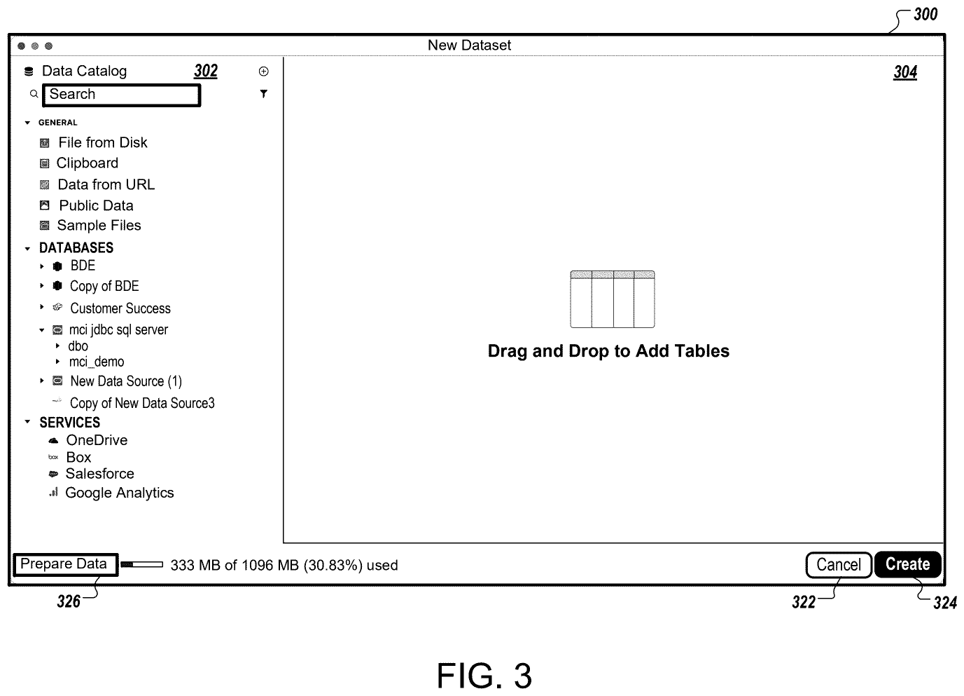

FIG. 3 shows another example of a user interface 300 for specifying the data to be used by a chatbot. For example, the user interface 300 is an example of an interface that can be shown after the administrator 103 selects the control 220 to create a chatbot with new data. The interface 300 allows the administrator 103 to create a dataset as an aggregation of data, from existing data sources already present in the database system 120 and/or through importing outside data sources.

The user interface 300 includes a data catalog 302 showing a variety of sources of data available to the administrator 103, such as files from disks, clipboard contents, data from URLs, public data, sample files, databases, or third party services that provide storage. The data sources made available from the data catalog can include locally stored data, as well as remotely storage data from, for example, a company network, a cloud computing service, and other data providers. The data catalog 302 enables the administrator 103 to browse and select data sets, and/or to search and filter existing datasets to find and select appropriate data for creating the chatbot.

The user interface 300 also includes a drop area 304, where a user can drop tables or other data sources to include them in the scope or set of available data for the chatbot being created. For example, after browsing the data catalog 302 or searching the data catalog through to, the user can drag items found from the data catalog panel to the drop area 304 to select them for use by the chatbot. And some implementations, the collected set of datasets that the administrator 103 drags and drops to the drop area 304 can be combined or specified as the collection that the chatbot can access.

In some implementations, the drop area through four or a similar area enables the administrator 103 to drag and drop files or other data from outside the data catalog 302 in order to import new datasets. For example, the administrator 103 may drag and drop a spreadsheet or database file on the drop area 304 to initiate importing of the data and selection of that data for use by the chatbot.

The user interface 300 includes a control 326 that enables the administrator 103 to prepare or refine the dataset to be used by the chatbot. The interface 300 also includes a control 324 to initiate creation of the chatbot based on the dataset selected or created using the interface 300. The interface 300 also includes a cancellation button 322 to cancel the creation or importing of a new dataset.

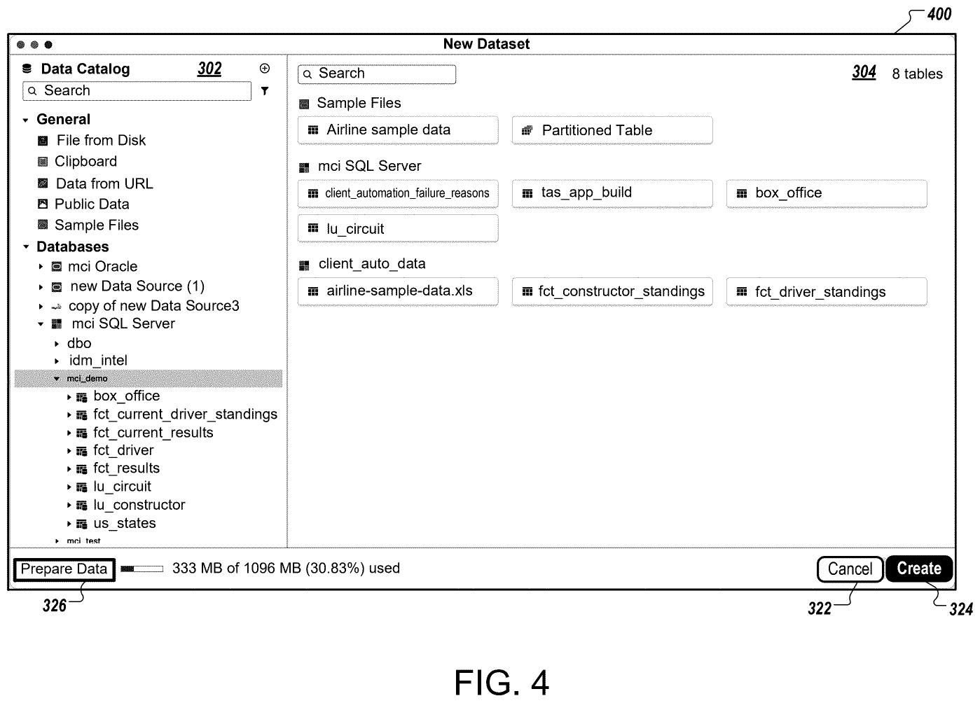

FIG. 4 shows another example user interface 400 that the administrator 103 can use to specify the data that the chatbot will be able to use. In the example, the administrator 103 has dragged a number of files and data sources from the data catalog 302 to the drop area 304. As a result, the drop area 304 has been updated to show the files and tables that, together, will form the dataset that the new chatbot can access. In this case, there are nine items shown, organized into three categories based on the relationships of those data sources. When the administrator 103 is satisfied with the collection of data specified, the administrator 103 can select the control 324 to proceed with creation of the chatbot, or may select the control 326 to prepare the dataset further.

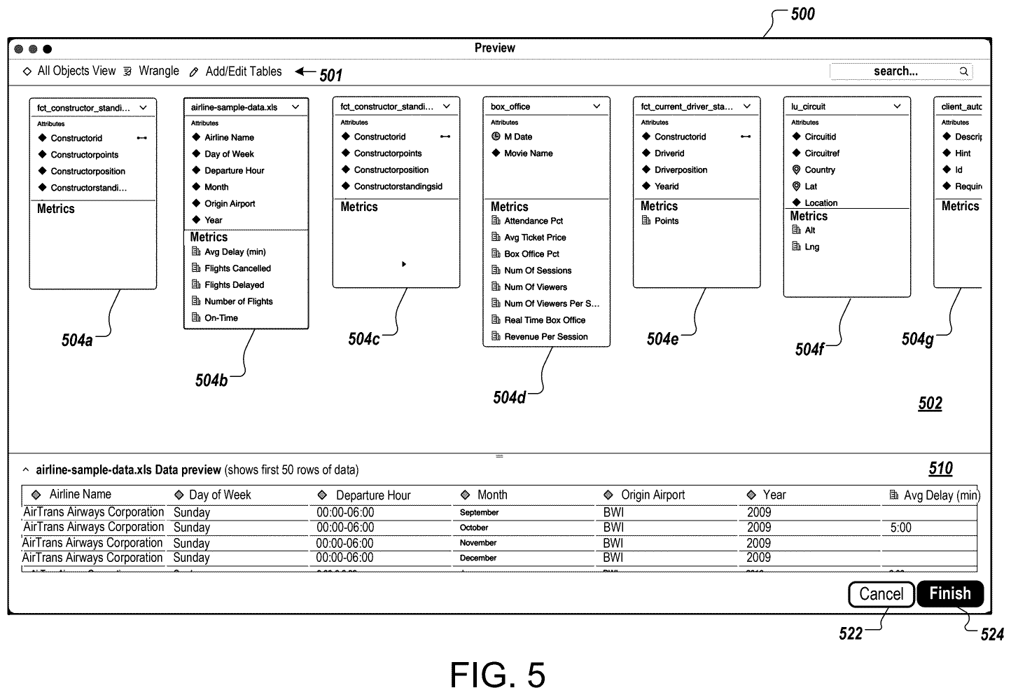

FIG. 5 shows another example user interface 500 that the administrator 103 can use to prepare data before finalizing the dataset for the new chatbot being created. For example, the system can provide the user interface 500 to the administrator 103 after the administrator 103 interacts with the control 326 that initiates the data preparation process.

The user interface 500 provides controls that can initiate various operations for preparing the dataset for the chatbot. For example, a number of controls enable an administrator 103 to add or edit tables, wrangle data by standardizing, filtering, joining, or otherwise manipulating the data.

The user interface 500 includes an object view area 502 that shows the objects in the dataset and their properties. For example, after the administrator 103 has selected the tables shown in FIG. 4, each of those tables can be represented in the object view area 502 with an object representation 504a-504g. These object representations 504a-504g each indicate the attributes available in the corresponding data object, as well as metrics available. For example, the object representation 504b represents the airline-sample-data.xls spreadsheet file, and indicates that this object includes attributes of airline name, day of week, departure hour, month, origin, airport and year, as well as metrics average delay, flights canceled, flights delayed, number of flights, and on-time measure. The attributes and metrics for each of the other data objects are also provided. More generally, the interface 500 can indicate the structure and contents of datasets, by providing information about the data, schema, dimensions or data types included, and so on.

The interface 500 also includes a data preview area 510, which shows example records or rows from a selected object. For example, when the administrator 103 selects the object representation 504b, the system populates the data preview area 510 with the sample rows of data shown.

These are interface 500 also includes a control 522 to cancel the data preparation and data preview, as well as a finish control 524 to finish the data preparation and continue with creation of chatbot.

FIG. 6A shows another example user interface 600 that the administrator 103 can use to specify properties and behavior of the new customized chatbot. For example, after the administrator 103 has specified the dataset to be used by the chatbot and the administrator 103 has made any changes or updates desired to prepare the dataset, the interface 600 can be displayed so that the administrator 103 can edit the chatbot.

In some implementations, new chatbots are created with an initial set of default chatbot settings 154 as shown in FIGS. 1A-1B. The administrator 103 can change the settings of the chatbot using the interface 600 to alter or customize the settings to change the appearance and operation of the chatbot.

The user interface 600 includes two major areas, a chatbot preview area 602, and a editing interface 610. The preview area 602 provides a functional, interactive interface for the administrator 103 to view and test the chatbot during the editing process. For example, after the administrator 103 changes a setting using the editing interface 610, the changes to the appearance and operation of the chatbot are reflected in the preview area 602. This allows the administrator 103 to iteratively adjust and test the chatbot with different settings, with real-time or near-real-time feedback that indicates how changed settings affect the user experience for the chatbot.

The preview area 602 provides a chatbot interface 603 and a snapshot region 604. In the chatbot interface 603, and icon or image for the chatbot is shown as well as an initial message to the user. In addition, the chatbot interface 603 includes automatically generated suggestions 605 of user prompts that can be selected in order to request a response. In addition, the chatbot interface 602 includes a text input field 606 for the administrator to type or otherwise enter a user prompt to the chatbot. The snapshot region 604 shows previous responses of the chatbot that have been saved for later viewing. The editing interface. 610 includes a number of tabs or areas with controls for specifying different categories of settings. For example, a general settings tab 620 is shown, which includes controls that enable the administrator 103 to specify general properties of the chatbot interface 603 that users will see. For example, the general settings tab 620 includes a text field 623 in which the administrator 103 can enter or edit an initial message that the chatbot provides to users. This message is shown in the preview area. 602, demonstrating how settings specified in the editing interface. 610 are applied to show the effect in the preview area of 602. As another example, a control 628 enables the administrator 103 to specify the number of automatically generated suggestions that are shown to users. The current selection of three automatically generated suggestions is shown in the preview area 602 as three suggestions 605.

FIGS. 6B-6E show tabs or regions of the editing interface 610 in greater detail.

FIG. 6B illustrates the general settings tab 620 in further detail. For example, the general settings tab 620 includes a text field 621 for the administrator 103 to specify a name for the new chatbot. In addition, a control 622 enables the administrator 103 to toggle whether the chatbot is active or not, e.g., whether the chatbot can be used or accessed by other users. In addition, the general settings tab 620 includes a text field 623 to provide a greeting or initial message to users, as discussed above.

The general settings tab 620 also includes controls for the administrator 103 to enable or disable other chatbot features. For example, the control 624 sets whether or not users will be able to save responses from the chatbot as snapshots, which can be displayed in a snapshot region 604. The control 625 enables the administrator 103 to specify whether the chatbot will be able to access data from the Internet to respond to user prompts. If disabled, as shown in the example, the chatbot will be limited to deriving responses from the dataset that corresponds to the chatbot, and potentially content generated by the AI/ML models 132. If the control 625 is enabled, the chatbot will be permitted to access additional data sources from the Internet, such as public records or third-party web sites to answer user prompts. This can be helpful in the event that users ask for information that is not in the dataset for the chatbot. On the other hand, limiting the data source from which the chatbot provides answers can help ensure the quality, relevance, and predictability of responses from chatbot.

The general settings tab 620 also includes controls that adjust how users provide user prompts to the chatbot. For example, a text field 626 enables the administrator 103 to specify a hint or instruction to users that can help the users know how to interact with the chatbot. In addition, a control 627 the specifies whether, the chatbot interface 603 provides suggestions, and a control 628 enables the administrator 103 to select how many automatically generated suggestions are shown. In addition, a control 629 enables custom suggestions to be added for display to users on the chatbot interface 603. In some implementations, the administrator 103 may desire to limit the rate that users submit questions and/or the total number of questions. Any given user can submit over a period of time. For example, The general settings tab 620 can include a control 630 for the administrator to specify a limit of how many questions each user can submit per month. The amount of computing resources required to perform inference using AI/ML The models 132 is significant, and may incur financial costs or result in congestion and delays. If not limited, administrator 103, they find a beneficial to impose reasonable limits to the number of user prompts or questions permitted. The general settings have 620 can also include an area for the administrator 103 to specify URLs or other references that can be helpful to users and which would be displayed on the chatbot interface 603.

FIG. 6C shows an example of an appearance settings tab 640, which includes controls that enable the administrator 103 to alter the appearance of the chatbot interface 603. For example, a control 642 and specifies whether the chatbot will be displayed in a panel or other region of a user interface. A control 641 enables an administrator to specify an image or logo for the chatbot by typing or pasting a URL for an image. Other controls adjust formatting, layout, another properties. For example, a panel theme control 643 enables the administrator to select from among different visual themes or styles to be used in displaying the chatbot interface 603. Similarly, a visualization palette enables the administrator 103 select from among multiple different color schemes that will be used in rendering visualizations provided by the chatbot, such as color schemes for charts, graphs, maps, and other visualizations.

FIG. 6D it provides an example of a custom instruction tab 660. Unlike the text fields of the general settings tab 620, which were primarily concerned with text and instructions viewed by the user of the chatbot, the custom instruction relates to instructions to the database system 120 and/or AI/ML model(s) 132 (e.g., LLM(s)) used to generate responses to user prompts. Using the custom instruction settings, the administrator 103 can tailor the content, style, and other properties of responses produced by the chatbot.

For example, the control 661 toggles whether the custom instructions are used in this chatbot or not. The control 662 is a text field to receive background information and context that will help improve the quality of responses from chatbot. For example, the administrator 103 can specify requirements about the dataset or business background and purpose of the chatbot. For example, if the chatbot is designed for use by an accounting department and there are certain conventions or preferences for presenting those responses, the administrator 103 can specify it in the text field of the control 662. The instruction can be specified in any of various ways, including as an instruction to a LLM or as a general statement of the purpose or intent of the chatbot being created. The custom instruction that the administrator 103 specifies can be included in the requests that the computer system 110 sends to the AI/ML service provider 130, and which are ultimately acted on by the AI/ML models 132. As a result, the instruction can be included as context processed by the AI/ML models 132 when generating responses. In this manner, even though the AI/ML models 132 are not trained specifically for the current chatbot that is being created, and the same AI/ML models 132 may be used for multiple chatbots, the current chatbot still produces consistently customized responses through the consistent use of the custom instruction. In other words, even though the AI/ML model 132 used by the chatbot may not specifically trained for this chatbot used, the computer system 110 can implement the customization desired by a pending the customer instruction to requests for this chatbot. The custom instructions can be provided to the AI/ML models 132 once per conversation (e.g., at the beginning of each conversation), with each user prompt 170, repeatedly after a certain amount of context is built to keep the custom instructions in the context, or in another manner.

The customer instruction tab 660 also includes a text field control 663 in which the administrator can specify the format of responses that the chatbot should use. As with the custom instruction entered in text field control 662, the text can be provided with requests that the computer system 110 sends to the AI/ML models 132 for this chatbot, so that the text in the text field control 663 is included as context for, or even an extended part of, at least some user prompt that will be provided to this chatbot that the administrator 103 is creating or editing. For example, the administrator 103 can enter in the text field control 663 information about the format of responses, such as a preference for a list of values, a summary followed by a table, or other instructions about the style or format that generated text should take. This instruction can be included with user prompts and/or requests from the computer system 110 to the AI/ML models 132 for this chatbot.

FIG. 6E shows an example of a data settings tab 680 that includes controls that enable the administrator 103 to manage the accessibility of the data in the dataset used to respond to user prompts. In some cases, the administrator 103 may desire to limit the chatbot to using only a subset of the data in the dataset to respond to user prompts. To achieve this, the administrator 103 can select, item by item, which types of data or sources of data to include or exclude from use by the chatbot. For example, the data settings tab 680 includes a list 682 of metrics, attributes, and other data items available in the dataset for the chatbot, as well as check boxes that can be used to individually include or exclude that data item from use by the chatbot. This provides the administrator 103 fine-grained control over the chatbot's use of the dataset. Using these features can also improve the relevance and quality of answers, because the administrator 103 can tailor the portions of the dataset available to the chatbot to the tasks, context, and overall needs of the users that the chatbot is designed for.

The data settings tab includes a search field 681 to receive keywords or query terms to search among the data items of the dataset for the chatbot, to allow the administrator 1032 more easily find and adjust the status of those data items. In addition, a context menu 683 or other region can include controls for editing, replacing, renaming, or otherwise changing the dataset that the chatbot uses.

In addition to the types of settings shown in FIGS. 6A-6E, The editing interface 610 can provide controls to specify or change other aspects of the chatbots, appearance and operation. For example, additional controls can be provided to specify access control properties, such as to specify users or user groups that are included or excluded from accessing the chatbot. In addition, controls can be provided for the administrator 103 to specify authentication requirements, and other policies or preferences regarding the chatbot.

After the administrator 103 has specified the settings for the chatbot, and is satisfied with the appearance and operation as observed in the preview areas 602, the administrator 103 indicates the chatbot is complete. The computer system 110 then generates the chatbot, including by saving the chatbot configuration data 146 and registering the chatbot so it is accessible to users.

FIGS. 7A-7B illustrate examples of interfaces and options for sharing or distributing a chatbot to users after the chatbot is created.

FIG. 7A shows a context menu panel 700 or other user interface region that can be shown to the administrator 103, potentially from the user interface 600 or another user interface. For example, the panel 700 can include options that the administrator 103 can select to share the chatbot through an email message, text message, in-application message, addition of the chatbot to a set of available chatbots in a library or chatbot listing, and so on. As another option, the panel 700 enables the administrator 1032 select to embed the chatbot in a user interface, such as in a website, web application, or other user interface. In addition, the panel 700 provides the administrator 103 an option to manage access to the chatbot, such as by editing a list of users or user groups for whom the chatbot is available.

FIG. 7B provides an example of a user interface 720 that assists the administrator 103 to share the chatbot that was created. For example, the user interface 720 can be presented in response to the administrator 103, selecting the “share bot” option from the panel 700.

The interface 720 includes a control 721 that enables the administrator 103 to set the permissions that the recipient of the sharing message will have. For example, the administrator 103 can specify to increase, decrease, or keep the existing permissions of the recipients. The interface 720 includes a field 722 to receive identifiers for recipients of access to the new chatbot. For example, the field 722 can receive names, email addresses, or other identifiers, or may a trigger a selection interface for the administrator 103 to select from contact records of the administrator's organization. The interface 720 includes a field 723 for the administrator 103 to specify a message to the recipients, as well as a control 724 to initiate sharing of the chatbot. Upon interaction with the control 724, the computer system can send messages via email, text message, in-app messaging, or other means to notify recipients of their access to the chatbot. In addition, or as an alternative, the chatbot may be shared in the form of updating a toolbar, homepage, document or object listing, or other interface to add the new chatbot as an object or option for the users to access. The computer system 110 also updates access control lists and other permissions related to the chatbot so that the recipients specified in the field 722 our granted appropriate access to use the chatbot.

As another option, the administrator can share access to the chatbot using a URL or other reference. For example, the interface 720 may provide a URL 725 for the chatbot, which may operate for anyone that uses the URL. The user interface 720 can include a control 726 to copy the chatbot access URL 725 to a clipboard or other interface to facilitate dissemination to other users.

FIG. 8 shows an example of the chatbot interface as it can be displayed on user interfaces of client devices 106a-106c of the users. 105a-105c with which the chatbot has been shared. Similar to the preview area 602 of FIG. 6A, the user interface 800 includes a chatbot interface 810, in which the user enters prompts to the chatbot and the chatbot provides responses. In addition, the interface 800 includes a snapshot area 820 that shows chatbot answers that the user has saved and for the detail, the chatbot interface 810 includes the greeting 811 that the administrator 103 specified for the chatbot along with the name (“SMART-E”) and logo that the administrator 103 specified for the chatbot. In addition, the chatbot interface 810 includes three suggested user prompts 812 as the administrator specified.

The interface 800 of FIG. 8 demonstrates how a few of the settings that can be specified for the chatbot are carried through to the appearance and operation of the chatbot experienced by users. In addition, the customizations specified by the administrator 103 and saved in the saved chatbot configuration data 146 are also used to customize the content and format of responses generated and provided through the chatbot interface 810. For example, the chatbot provides answers based on the particular dataset that the administrator 103 selected or generated using the features of the interfaces in FIGS. 3-5. In addition, the responses generated by the chatbot are limited to the subset of data from that dataset as specified by the selections in the data settings tab 680 of FIG. 6E. In addition, interactions of the computer system 110 with the AI/ML models 132 can include or otherwise incorporate the information from the custom instructions specified in the custom instruction tab 660. For example, when the user 105c submits a question through a text field 814 of the chatbot interface 810, the computer system 110 can supplement or augment the user's question with the custom instructions, e.g., as additional prompt content or as context for the user prompt. In a similar manner, the computer system 110 can use the settings for the chatbot, as saved in the saved chatbot configuration data 146, to customize or create each interaction with the AI/ML service provider 130 and AI/ML models 132, with the database system 120, and with client devices 106a-106c. As a result, the saved chatbot configuration data 146 that captures the settings of the administrator 103 for the chatbot can be applied consistently and repeatedly for many users to provide a customized chatbot experience. In addition, other chatbots that use the same AI/ML models 132 and potentially even the same dataset(s) have their own separate appearance, behavior, and content of responses, as specified by the respective saved configuration data for those chatbots.

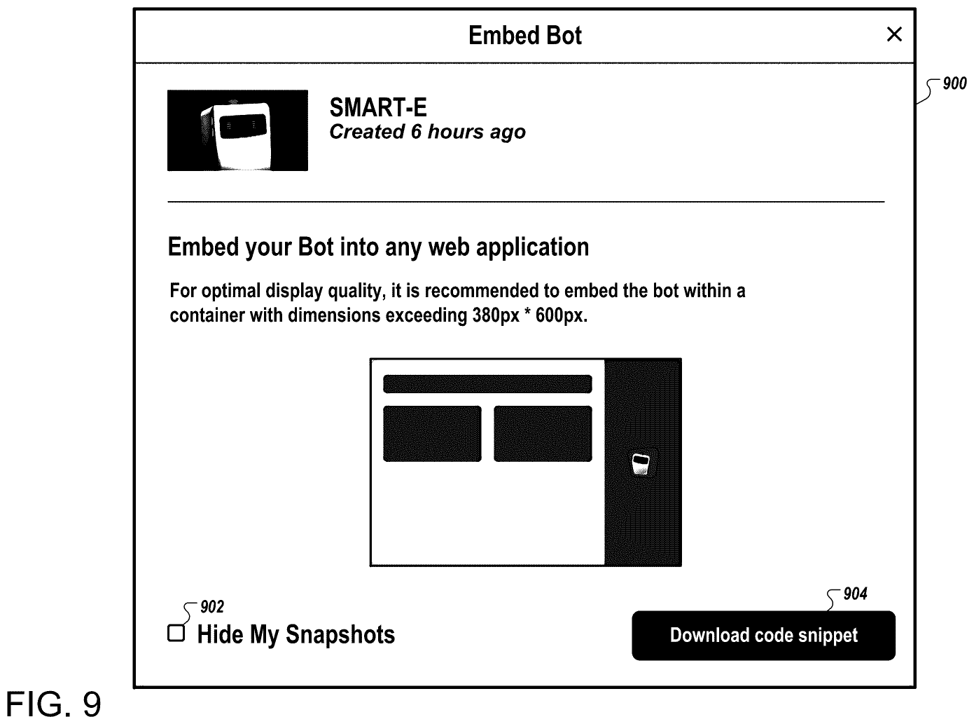

FIG. 9 shows an example user interface 900 explaining to the administrator 103 how the chatbot can be embedded in web applications. The user interface 900 explains that the recently created chatbot, named “SMART-E,” can be embedded into web applications, such as a container with at least certain minimum dimensions. The user interface 900 can provide controls for the administrator to specify settings for the chatbot when embedded, such as the checkbox control 902 to specify whether features for users to save and view answers from the chatbot, e.g., the “My Snapshots” feature, should be enabled in the embedded view of the chatbot interface. The user interface 900 has a download control 904, such as a button, that the administrator 103 can interact with to obtain a code snippet (e.g., HTML code, JavaScript code, etc.) that will embed the chatbot interface into a region of a web page or web application (e.g., in a container, frame, iFrame, etc.). The computer system 110 generates the code snippet to provide the interface to the specific chatbot the administrator 103 is working with. The code snippet can include, for example, components such as a URL, size parameters, border or formatting parameter values, and parameter values setting other appearance or behavior (e.g., whether scrolling is allowed, etc.).

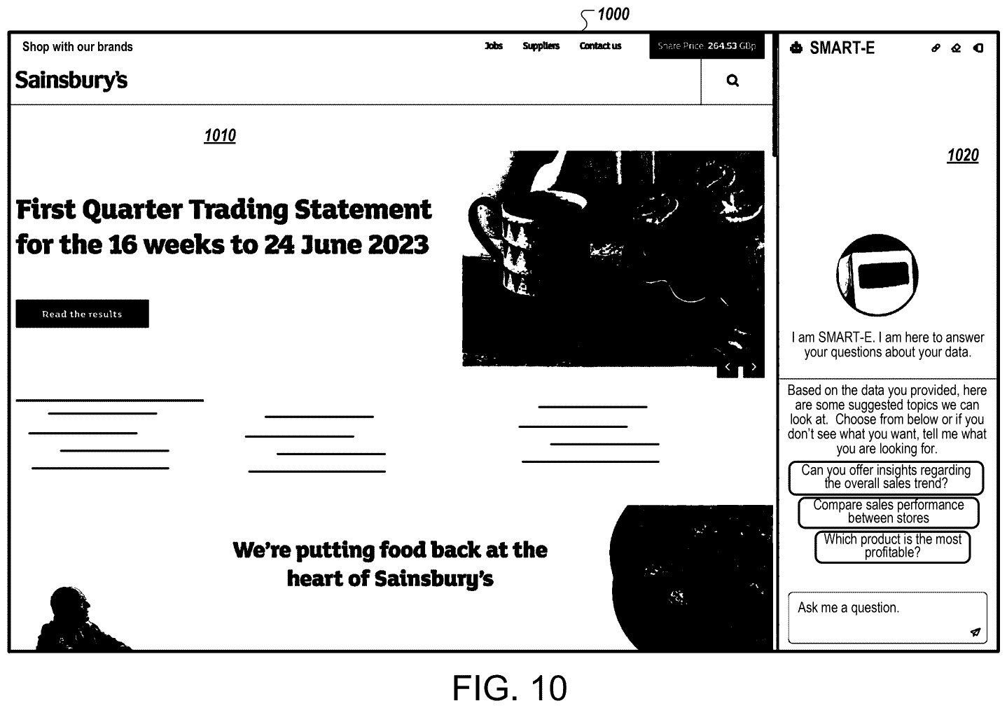

FIG. 10 is an example of a user interface 1000 in which the chatbot interface 1020 has been embedded in a web page 1010 or web application as an inline frame. When the main web page 1010 or web application is loaded, the chatbot interface 1020 can be automatically loaded in the designated area, as illustrated. In some implementations, the chatbot interface 1020 is not initially displayed upon loading of the web page 1010, but is instead expanded or invoked in response to a user interacting with a portion of the web page 1010, such as a button, icon, or message text designated to bring the chatbot interface 1020 into view.

In some implementations, the chatbot interface 1020 is provided in other ways, such as through an extension module or toolbar module for a web browser. For example, as an add-on module for a web browser, an icon can be displayed in the web browser interface, independent of the web page or web application that the user navigates to. The add-on module can be configured to display the chatbot interface 1020 alongside, or as an overlay over, any web page or web application being displayed, in response to a user interaction to present the chatbot interface 1020.

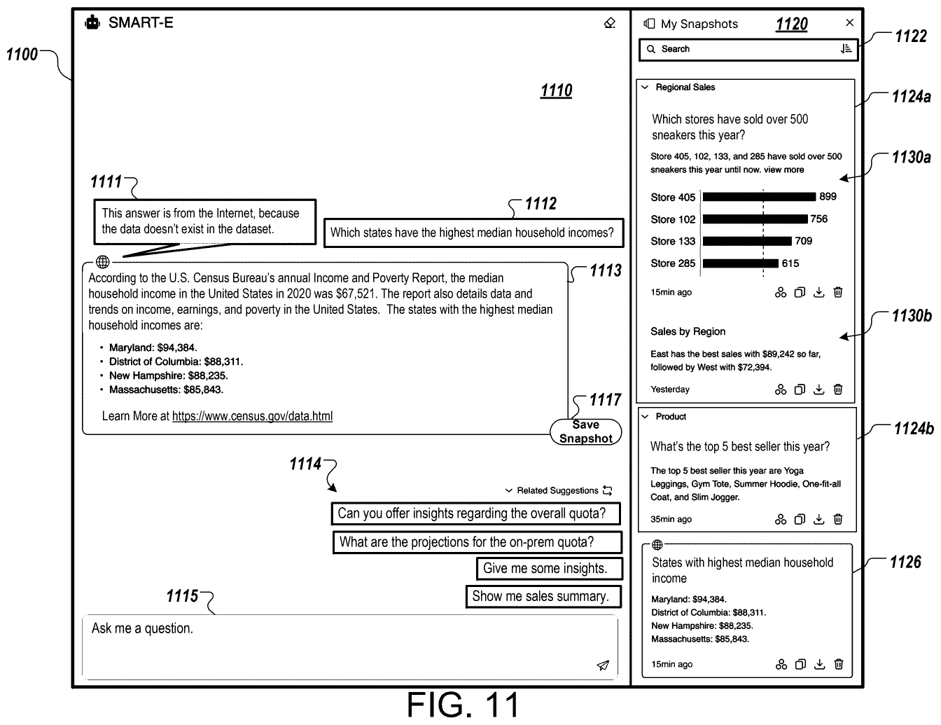

FIG. 11 is another example of a user interface 1100 showing user interactions with the chatbot. The user interface 1100 has a main area 1110 that shows a user prompt 1112 that was submitted and the response 1113 from the chatbot. The chatbot added a comment 1111 that the answer is taken from the Internet data because the data requested about median incomes by state was not in the dataset 122a. In this example, the administrator 103 previously specified that the chatbot can use data from the Internet, by setting control 625 of FIG. 6B appropriately. As a result, the chatbot was able to determine from the initial request for data processing instructions and lookup from the dataset 122a that the requested type of information was not available, and so the search should be expanded to include information from the Internet. The main area 1110 also includes a set of related suggestions 1114 that the chatbot provides. These suggestions can be selected based on prior prompts submitted by the current user, other users, and/or statistical likelihoods, even potentially from information generated from a LLM such as one of the AI/ML models 132.

The user interface 1110 also includes a snapshot area 1120 for viewing, searching, and organizing saved information from conversations with the chatbot. When a user finds information in the chat conversation to be helpful, the user can save the response for later viewing or other use by interacting with a save control 1117. In response, the computer system 110 creates and saves a record representing the corresponding prompt 1112 and response 1113, in this case, as snapshot 1126. The snapshots can be concise or summarized versions of the corresponding prompt and response, and these snapshots can be stored separately for each user. The stored snapshots can persist across different sessions of using the chatbot, and can be synchronized across different interfaces for accessing the chatbot. As a result, over the course of several different days, when the user accesses the chatbot at different times, and whether accessed from an embedded interface in a web application or from a stand-alone interface in a mobile app, the user can view the snapshots and add to them.

The snapshot area 1120 can include snapshots organized by topic or keyword, for example, a snapshot group 1124a includes a first question and answer 1130a as well as a second response to a question 1130b that is related. Another snapshot 1124b relates to another topic. Each snapshot 1130a, 1130b, 1124b, 1126 can include controls for the user to expand or contract the view, copy the snapshot content to a clipboard, share with other users, download the content, or delete the snapshot to remove it from the view 1120. The snapshot area 1120 also includes a search control that enables the user to perform text searching of the snapshots.

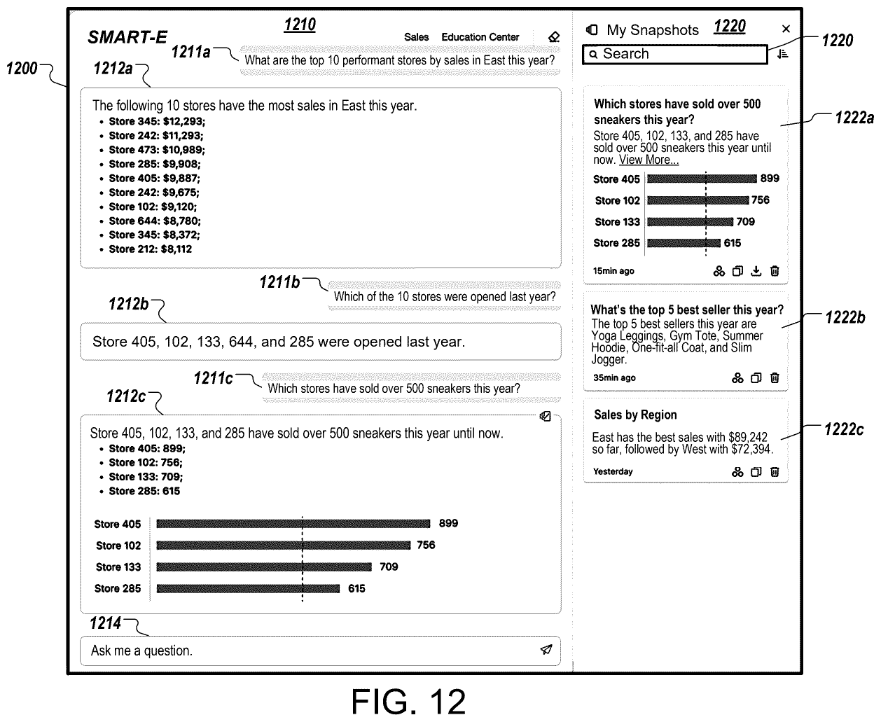

FIG. 12 is another example of a user interface 1200 for a user to interact with the chatbot. A main area 1210 includes various user prompts 1211a-1211c and corresponding responses 1212a-1212c of the chatbot, along with a prompt entry field 1214. In addition, the user interface 1200 includes a snapshot area 1220 with a search control 1220 and several saved snapshots 1222a-1222c that the user previously saved.

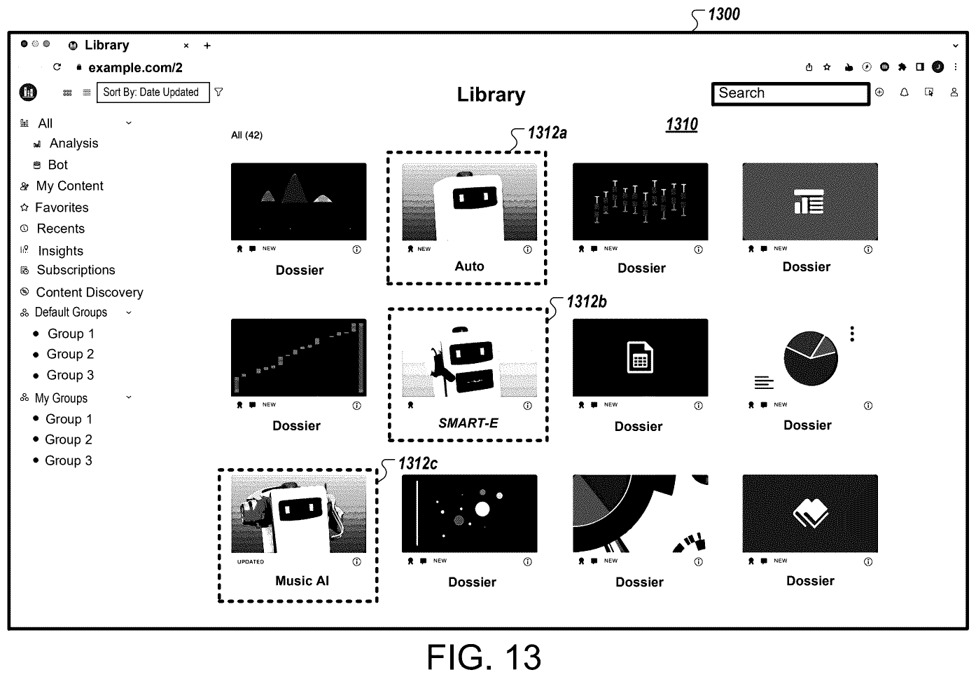

FIG. 13 shows an example of a library user interface 1300 where a user can access various types of information, such as documents, dashboards, databases, applications, and so on. The interface 1300 can include icons or other representations of chatbots 1312a-1312c. The interface 1300 enables the user to invoke any of these chatbots 1312a-1312c by interacting with the corresponding user interface element shown, which will initiate display of a text interface for the corresponding chatbot. The library user interface 1310 is yet another example of the many different entry points or access methods by which users can gain access to customized chatbots.

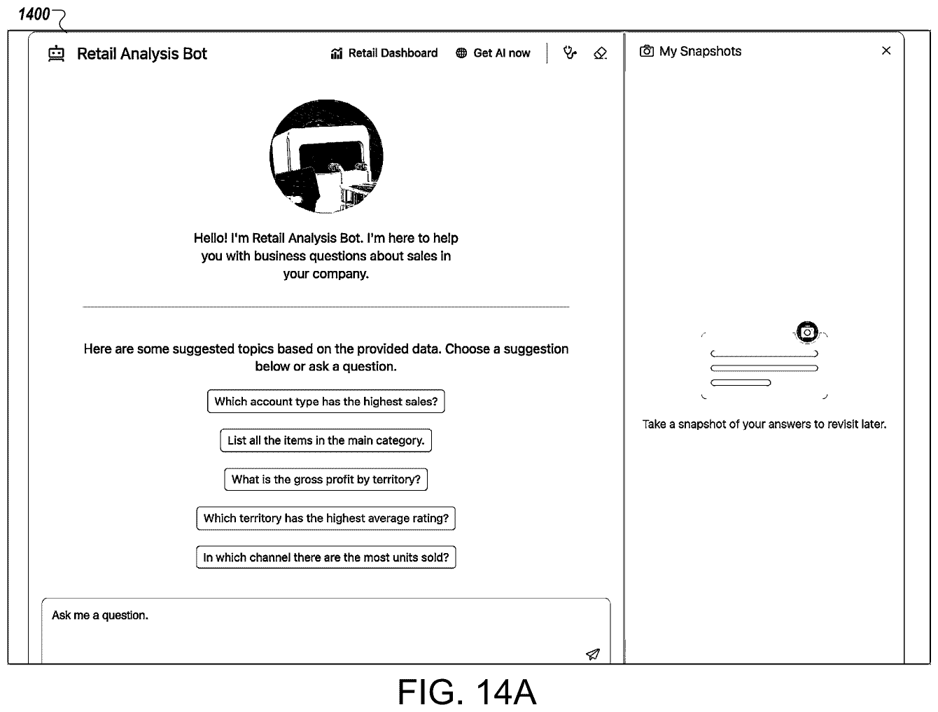

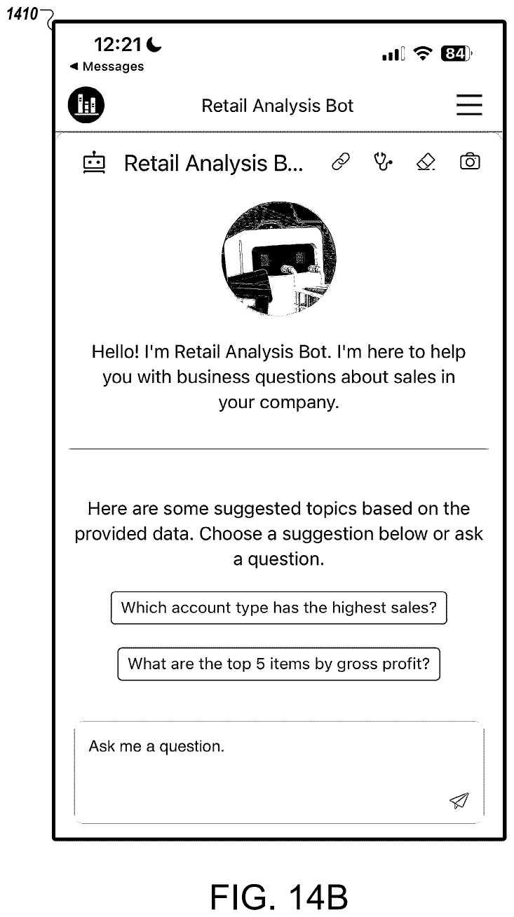

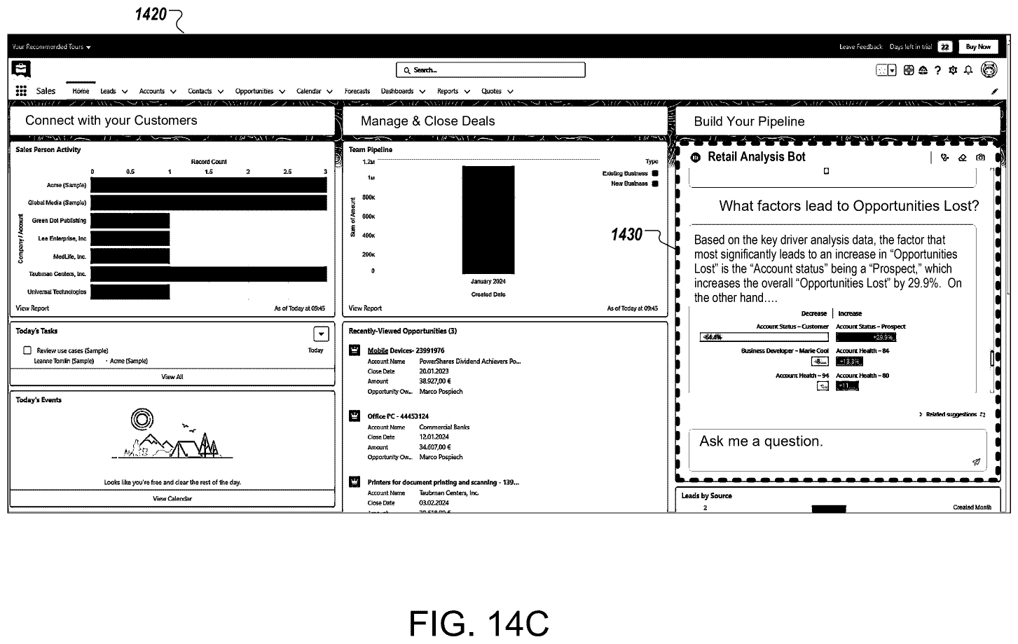

FIGS. 14A-14C show how the system enables a customized chatbot to be accessed through any of multiple different interfaces. This can include embedding the chatbot into a third-party interface (e.g., a web page, a web application, a third-party stand-alone application, a third-party platform such as Slack, Microsoft Teams, Salesforce, etc.). As a result, the same customized chatbot can be accessed through any of various different interfaces or platforms.

In these examples, the computer system 110 can act as a server that provides the chatbot as a software-as-a-service (SaaS) product to customer organizations. The cloud-computing-based platform provided by the computer system 110 hosts chatbots for the organizations, including customized chatbots with customer-defined settings and an organization's own private datasets. The organizations can then provide access to customized chatbots to their users (e.g., employees, the organization's own customers, etc.). The computer system 110 provides an easy way for organizations to access customized chatbots without requiring their own dedicated hardware, and with straightforward integration, often by simply embedding code that the computer system 110 provides into a web page, web application, dashboard, report, or other interface.

To support chatbot interfaces on multiple platforms or devices, the computer system 110 can generate and provide the configuration data, embedding code, links, and other content that enable multiple interfaces (e.g., on different device types, different operating systems, etc.). The computer system 110 can continue to host the chatbot and manage the processing of queries and generation of responses. In many cases, this can be provided as a software-as-a-service (SaaS) offering, with cloud-computing-based hosting for the customer (e.g., the company or organization creating and offering the customized chatbot to its users). For example, the computer system 110 can (1) provide the gateway or API through which prompts are received, (2) manage or coordinate data access to the data sets 122a-122n (and potentially host the data storage and database management system also), (3) interface with the AI/ML models 132), and (4) generate and provide the final responses to user prompts.

The computer system 110 can generate and provide to the administrator content for the chatbot interface itself. This can take any of various forms, such as the software of a desktop application or mobile device application that includes the executable or interpretable code that a client device can run to render and display an interface to access the chatbot. The computer system 110 can generate the application by updating an application template or with the specific identifiers, names, formatting, content, network addresses, API keys, security certificates, and other content to target the application to a particular custom application (or set of multiple custom applications). As another example, the computer system 110 can generate and host code for a web page, web application, or other dynamic interactive active document, and the computer system 110 can provide the administrator a Uniform Resource Locator (URL) or other address or identifier that can direct a web browser or other application to the interface for the customized chatbot.

As another example, the computer system 110 can generate and provide a JavaScript module to enable the administrator to quickly embed the customized chatbot into another application or document by inserting a few lines of JavaScript code that the computer system 110 generates. This can enable the administrator to insert a chatbot interface into a native application, web page, web application, dashboard, or other existing interface or document. The embedding code can include an address or identifier so the embedding targets and makes available a specific customized chatbot (or potentially a collection of multiple customized chatbots selected by the administrator or offered by a particular organization). On the client device, processing the embedding code can then cause a client device that renders or displays the interface with the embedding code to communicate with the computer system 110, retrieve the interface data for the embedded chatbot interface, and display the chatbot interface alongside and in context of the other content in which it is embedded. In some cases, the chatbot interface can be provided in a widget, container, frame, iFrame, using <embed> or <object> tags, or in other ways. The computer system 110 can also support more fine-grained control to leverage a customized chatbot in custom scenarios, such as integration with third-party messaging platforms, through APIs. The computer system 110 can generate and provide code for making API requests (e.g., software add-on modules, API keys or identifiers, etc.) or integration configuration data packages for these types of platforms. In some implementations, these include modules that reside on the client device (e.g., application extensions, application add-on modules, or client-side agents). In addition, or as an alternative, the computer system 110 can generate and provide server-side modules that configure server environments to provide or support embedded chatbot interfaces, or connect to chatbot backend systems like the computer system 110 through one or more APIs.

FIG. 14A shows a user interface 1400 for a chatbot named “Retail Analysis Bot,” showing the chatbot in a stand-alone interface. The interface includes components areas for text entry of a prompt by a user, suggested topics or suggested queries, and an area for saved answers or “snapshots.” The chatbot interface can be provided as the primary content of a web application, web page, or native application. The processing of user prompts and generation of responses is performed as discussed above, with the computer system 110 receiving prompts, managing the retrieval of data and generation of responses, and providing the answers for display in the interface.

FIG. 14B shows a user interface 1410 showing an interface for the same “Retail Analysis Bot” chatbot shown with a user interface on a mobile device. The interface can be provided through a mobile application, a web application, a web page, etc. The computer system 110 again coordinates and manages the processing of prompts and the generation of answers for the chatbot.

FIG. 14C shows the same “Retail Analysis Bot” chatbot integrated into a web page. The example shows a user interface 1420 that shows a web page or web application, with multiple different sections or panels. A chatbot region 1430 is embedded in the interface, alongside other regions showing, for example, messaging, calendar data, data visualizations (e.g., charts, graphs, tables, etc.), and other content. In this case, the computer system 110 generated and provided a code snippet that provides a connection to the chatbot functionality hosted by the computer system 110. By embedding the code into the document shown in the user interface 1420, loading the document causes a client device to retrieve and render the chatbot interface, as well as send prompts and receive answers over the communication network.

As shown through the description above, the chatbot is more than a. AI/ML model, such as an LLM, it includes the additional settings such as custom instructions, formatting, interactive behavior, question suggestions, knowledge bases, data set selection, and so on. As a result, a chatbot represents a customized window or interface to a AI/ML model, in effect a filter that customizes and enhances the user experience when submitting prompts and receiving answers. Even if the same prompt is sent to two different chatbots based on the same AI/ML model, the answers from the chatbots will often be different due to the settings of the chatbots, including the different data sets, knowledge bases, custom instructions on answer formats, and so on.

In some implementations, the computer system 110 provides data for an administrator interface, where multiple types of embedding options are provided (e.g., different program languages, destination document types, programming languages or markup languages, etc.). The administrator can choose from among the multiple embedding methods and the computer system 110 will generate and provide the code snippet for integrating the chatbot interface. There are several ways that a chatbot interface can be embedded. For example, the code snippet can be for a button or hyperlink that is configured so that when a user clicks the button or link, the client device triggers a popup, an overlay, or an expansion of a user interface region to show the chatbot. In some cases, interacting with the control defined by the embedding code causes an event or function call that passes a parameter (e.g., a parameter value, such as an identifier) that points to the chatbot (e.g., a computing environment and/or chatbot identifier). These features can be supported by a client-side extension, plug-in module, or add-on module, such as a module that integrates or runs alongside a web browser on the client device, and which handles events that reference chatbots. The extension module can be configured to point to a specific chatbot or to handle parameters received from various events or function calls to provide interfaces to any of multiple different chatbots according to the parameters received.

In some implementations, a chatbot interface is embedded through other code, such as HTML code or other document code that displays the chatbot interface directly in a region of a user interface, and which uses an API to send and receive communications with the chatbot. The computer system 110 or another server can provide an API gateway to handle various types of requests, e.g., authenticating users, establishing sessions, sending prompts, transferring answers, obtaining context data, etc.

The ability to embed access to chatbots in any of a variety of documents, interfaces, and platforms is a significant advantage. In many systems, it is important to reach most if not all users, including the edges of the technology ecosystem, e.g., all varieties of end users and not simply data analysts, data architects, and other users with specialized technical knowledge. The features of the computer system 110 allow organizations to build a chatbot and embed it in the systems and interfaces that employees and other users are already using and are familiar with. This includes the ability to embed the chatbot in third-party interfaces such as Salesforce, Workday, messaging platforms, videoconferencing platforms, and so on. The computer system 110 allows organizations to embed an agent, e.g., a chatbot, so that users can ask questions and receive answers directly. This significantly reduces barriers to adoption of chatbots for users and reduces cost and complexity for software developers and information technology professionals. Another advantage is the ability to integrate the chatbot in any of various ways or interfaces, such as a web snippet (e.g., a piece of code) with a minimal interface, to embed whole chatbot interface directly, to include a hyperlink directing a user to the chatbot, an icon or other control that responds to interaction by revealing a chatbot interface (e.g., an overlay, flyover, drop down area, etc.), and so on.

Access to chatbots, whether through a stand-alone interface or through an embedded interface, can be governed by a security procedures. For example, users can be required to authenticate, through single-sign-on (SSO) system or to log in directly. The computer system 110 can store an access control list and/or permissions for each chatbot of each organization, and can enforce limits to so that users are only provided access to the chatbots they are authorized to access. Even after authenticating, the chatbots acting to answer a user's question only access data that the user is authorized to access.

In each of the various ways that a chatbot is embedded or integrated with other systems or interfaces, the chatbot's context is defined by (e.g., is an intersection of) the user's privileges or authorization level, the collection of data the chatbot is designed to use (e.g., the selected data set(s) 122a-122n and any restrictions set for the chatbot), and the access control lists or other policies that govern access to the data sources the chatbot is designed to use. The way the chatbot is invoked can also modify the context that is provided to or used by the chatbot. In some implementations, for example, the computer system 110 receives and uses information about the interface in which the chatbot is embedded to tailor the context and/or behavior of the chatbot. For example, requests to the computer system 110 including user questions from an embedded chatbot interface can include an identifier (e.g., name, code, URL, etc.) for the document, page, web site, etc. in which the chatbot interface was embedded. In some cases, the identifier for the interface where the chatbot is embedded can be used to look up a profile with settings, history, custom instructions, or other information beyond the general chatbot configuration, to tailor behavior to the specific situation or use case of the embedding. For example, the chatbot can use different additional instructions or settings for different web sites in which it is embedded. Other information can additionally or alternatively be provided about an interface the chatbot is embedded in, such as values indicating the topics, interface type (e.g., mobile, web document, etc.), or other characteristics of the surrounding environment in which the chatbot interface is embedded. These pieces of information can then also be used to look up further customized settings or instructions that adjust the output and behavior of the chatbot.

In some implementations, the chatbot receives input of content of the interface that the chatbot is embedded in or invoked from. The context of the chatbot can be expanded in some ways and limited in other ways to tailor the scope of information used to answer a user's question. For example, the content of the current user interface (e.g., text in the current page or view) as well as underlying data (e.g., result data represented in visualizations in the current page or view) can be gathered and provided with a user question, and that content can be included in the context accessible by the chatbot in answering the user question. As another example, the chatbot interface components can send an indication of the specific data set(s) 122a-122n referenced by or relevant to the content of the interface in which the chatbot is embedded or from which the chatbot is invoked (e.g., by clicking a button, hovering over an icon, by entering a question into a field, etc.). The computer system 110 can then limit the data that is used by the chatbot to answer the question, so the answer is taken from the particular data set(s) related to the interface the user sees. For example, the chatbot may be designed to answer questions from three different data sets, but the chatbot is embedded in a web page that involves data from only a single of these data sets. When a question is received through the embedded interface, the embedded interface sends the user question with information indicating this information, e.g., an identifier for the page, an identifier for the data set, content of the page that includes references to only that data source, etc. In response, the computer system 110 generates the first request (e.g., request 172) to limit the scope of data to the particular data set 122a-122n that is relevant. Then, the data processing instructions 174, the results 176, the second request 178, and ultimately the response 182 will all be based on the particular data set identified to be relevant. In some implementations, if the user has applied any additional filters (e.g., limiting data of a visualization or other content to a particular range of time, geographical scope, set of items, etc.), those filters are applied also in the requests to the AI/ML model 132 and the generation of results 176 from the data processing system 120, so the answer will be generated with data corresponding to the scope of data that the user has specified.

An embedded or integrated chatbot can use the content or context of surrounding or accompanying interfaces in other ways. In some implementations, there is an software agent module running on the client device configured to gather on-screen content (e.g., of a user interface, document, etc.) and provide it in response to a user interaction to gain access a chatbot interface or to submit a question through a chatbot interface. As another example, software supporting chatbots can be integrated with an application, so the chatbot is provided with the context of the current page, section, document, or application that is open. The computer system 110 can run the chatbot to include this context information in the processing of the AI/ML model 132, and can also instruct the AI/ML model 132 to base an answer if possible on the information shown on the user interface, and to use information from a data set if the answer is not present from the on-screen content. This can help the system synchronize or align the content of answers from the chatbot with the content that the user sees on the screen.

In some implementations, a chatbot can be registered with a messaging platform. For example, a chatbot can be shown to have a conversation with a user in the same way conversations can occur among users. In some implementations, the chatbot can be given an identifier that users can be used to invoke or trigger participation of the chatbot within a conversation. In this case, if the user includes a designation, such as “@Auto,” this signal can trigger the following statement to be processed by the chatbot, with the context of the previous messages in the conversation. This way, at any point in a text message conversation between users, a user can invoke the chatbot to enter the message exchange and answer a question, and the chatbot benefits from the context of the previous messages exchanged between the users in the conversation to make the response relevant and appropriate. The computer system 110 can appropriately gather the message conversation context information to provide to the AI/ML model 132, and the computer system 110 can also instruct the AI/ML model 132 to answer in a manner specific to the messaging use case. For example, the computer system 110 can use additional or different instructions to the AI/ML model 132 that are specific to the messaging use than when the chatbot is used in a stand-alone way. More generally, the computer system 110 can detect different situations or scenarios in which a chatbot is accessed (e.g., different interfaces or situations where the chatbot is embedded) and can customize the instructions and context data provided to the AI/ML model 132 based on the context. Thus, the same chatbot defined by an administrator can behave differently and appropriately for each of many different situations or interfaces in which the chatbot is embedded.

In some implementations, the chatbot interface is embedded into a contextually-presented information card. For example, a system can be configured to detect keywords in an interface, such as the name of a person, company, or other entity, and make the keywords interactive to trigger display of an information card containing information about the entity (e.g., information sources from a data set). The chatbot interface can be integrated with or embedded in the information card so that the information card has a text entry field where a user can ask a question, and the context of the information card (e.g., the company or other entity that is the subject of the card, the statistics or other indicators in the card, and the data set(s) the information in the card is source from) is carried through with the user's question. If the user has selected an item on the interface, that information can be provided also. As a result, the computer system 110 can obtain results from the database system 120 and coordinate generation of an answer using the AI/ML model 132 that is targeted to and customized for the context in which the chatbot interface and thus the user's question occurs. For example, in sending the first request and second request to the AI/ML model, the computer system 110 can take the entity or subject of the information card and instruct it to be used as a filter, so that the information returned relates to the same entity or subject of the information card.

In some implementations, the computer system 110 can store different chatbot profiles or sets of supplemental instructions corresponding to different chatbot uses or types of interfaces from which the chatbot is invoked. For example, the variations in settings or instructions can be specified by an administrator, or in some implementations a set of default customizations can be used for certain scenarios. For example, when the computer system 110 assembles instructions to an AI/ML model 132, the computer system 110 can combine or append certain instructions with the user's question. The computer system 110 can apply different sets of instructions for each of different user entry points to the chatbot conversation, e.g., a first instruction if the question was entered through a document library interface, a second instruction if the question was entered through an interface embedded in a web page, a third instruction if the question was entered through a messaging interface, a fourth instruction if the question was entered through an interface in an information card, and so on. In these cases, a common set of chatbot properties are used according to the saved chatbot settings defined by the administrator (e.g., which data sets to used, general instructions, response formats, etc.), but each different type of embedding or entry point for a question can cause an additional instruction or a modification to the settings to be applied, so that the behavior is tailored for the particular situation occurring at the time the question is asked. Of course, the computer system 110 also enables administrators to define multiple chatbots with different characteristics, and to cause different chatbots to be invoked in different circumstances or from different interfaces rather than situationally modifying a single chatbot based on the user entry point.

Over time, as a chatbot is used, the interactions of users can be recorded and tracked. Users can provide feedback about the answers given by a chatbot, such as to mark an answer as helpful or not, to give a rating with a number or other indicator, and so on. The system can update the chatbot over time, including with additional knowledge base content and user feedback, to improve the quality of answers over time. This learning can be done for the chatbot overall, across all the different interfaces or entry points where users can submit questions. As another example, the learning can be done separately for each interfaces, so that each place the chatbot is embedded can be improved based on the questions and interactions specifically intended for it. The computer system 110 can store and use separate user feedback data and learning results for each entry point to the chatbot, to better learn from and respond to the differing user behavior patterns that occur at the different types of entry points.

In some implementations, the system gives administrators the option to select from among different AI/ML models 132 and/or different options of AI/ML service providers 130. Each embedded use of the chatbot can be configured to use a different AI/ML models 132 or have other settings.

A number of implementations have been described. Nevertheless, it will be understood that various modifications may be made without departing from the spirit and scope of the disclosure. For example, various forms of the flows shown above may be used, with steps re-ordered, added, or removed.

Embodiments of the invention and all of the functional operations described in this specification can be implemented in digital electronic circuitry, or in computer software, firmware, or hardware, including the structures disclosed in this specification and their structural equivalents, or in combinations of one or more of them.

Embodiments of the invention can be implemented as one or more computer program products, e.g., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a tablet computer, a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD-ROM and DVD-ROM disks. The processor and the memory can be supplemented by, or incorporated in, special purpose logic circuitry.

To provide for interaction with a user, embodiments of the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the invention can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the invention, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

In each instance where an HTML file is mentioned, other file types or formats may be substituted. For instance, an HTML file may be replaced by an XML, JSON, plain text, or other types of files. Moreover, where a table or hash table is mentioned, other data structures (such as spreadsheets, relational databases, or structured files) may be used.

Particular embodiments of the invention have been described. Other embodiments are within the scope of the following claims. For example, the steps recited in the claims can be performed in a different order and still achieve desirable results.

1. A method performed by one or more computers, the method comprising:
receiving, by the one or more computers, data indicating user input instructing a chatbot to be created and an indication of a data set for the chatbot to use;
creating, by the one or more computers, the chatbot based on data objects in the data set, wherein the chatbot is configured to respond to user prompts based on data objects in the data set;
providing, by the one or more computers, a code segment or module configured to cause a chatbot interface for interacting with the chatbot to be embedded in a user interface;
receiving, by the one or more computers, a user prompt provided for the chatbot through the user interface; and
providing, by the one or more computers, a response to the user prompt from the chatbot, wherein the response from the chatbot comprises text generated by one or more artificial intelligence and/or machine learning (AI/ML) models using values from the data set.

2. The method of claim 1, wherein receiving the data indicating the user input comprises receiving a user indication to create the chatbot based on the data set or a document that references the data set, wherein the data set or the document has a corresponding group of settings; and
wherein creating the chatbot comprises creating configuration data for the chatbot to apply the group of settings to the chatbot based on the user indication and based on the group of settings being associated with the data set or the document.

3. The method of claim 1, wherein the one or more computers store a set of parameters configured to apply generally to chatbots of an organization or group; and
wherein the method includes applying the set of parameters to multiple chatbots of the organization or group.

4. The method of claim 1, wherein the code segment or module is configured to insert a chatbot interface for the chatbot into at least one of a native application, a web page, a web application, a dashboard, or a document.

5. The method of claim 1, wherein the code segment or module comprises an address or identifier configured to targets and provide an interface to access the chatbot or a collection of multiple customized chatbots that includes the chatbot.

6. The method of claim 1, wherein the code segment or module is configured to cause a client device, when the code segment or module is invoked at the client device, to display the chatbot interface alongside and in context with other content of a third-party user interface in which the chatbot interface is embedded.

7. The method of claim 1, wherein the code segment or module is configured to integrate the chatbot interface with a third-party messaging platform using one or more application programming interfaces (APIs).

8. The method of claim 1, wherein the code segment or module is configured to reside on and be invoked at a client device.

9. The method of claim 1, wherein the code segment or module comprises a server-side modules that configures a server environment to (i) provide or support the chatbot interface or (ii) connect to the one or more computers through one or more application programming interfaces (APIs) to provide access to the chatbot.

10. The method of claim 1, wherein the one or more computers provide an Internet-based interface to create the chatbot and host interaction with the chatbot on a software-as-a-service platform.

11. The method of claim 1, wherein the one or more computers are configured to (i) provide a gateway or application programming interface (API) through which prompts are received, (ii) manage or coordinate access to the data set, (iii) interface with one or more artificial intelligence and/or machine learning (AI/ML) models used to provide the chatbot, and (iv) generate and provide the responses to user prompts provided through the chatbot interface.

12. The method of claim 1, wherein the chatbot is configured to provide responses that are based on a context determined based on:
privileges or an authorization level for a user;
a policy that governs access to the data set; and
one or more restrictions set for the chatbot.

13. The method of claim 1, wherein the chatbot is configured to use information about the user interface in which the chatbot is embedded to tailor a context for the chatbot or behavior of the chatbot when generating responses to user prompts.

14. The method of claim 1, comprising:
receiving in association with the user prompt, an identifier for the user interface in which the chatbot interface is embedded; and
generating the response based on the identifier, including based on including information indicating a topic, an interface type, or characteristic of the user interface in which the chatbot interface is embedded.

15. The method of claim 1, wherein the one or more computers are configured to use different instructions or settings for the chatbot to generate responses from different user interfaces in which the chatbot is embedded.

16. A system comprising:
one or more computers; and
one or more computer-readable media storing instructions that are operable, when executed by the one or more computers, to cause the system to perform operations comprising:
receiving, by the one or more computers, data indicating user input instructing a chatbot to be created and an indication of a data set for the chatbot to use;
creating, by the one or more computers, the chatbot based on data objects in the data set, wherein the chatbot is configured to respond to user prompts based on data objects in the data set;
providing, by the one or more computers, a code segment or module configured to cause a chatbot interface for interacting with the chatbot to be embedded in a user interface;
receiving, by the one or more computers, a user prompt provided for the chatbot through the user interface; and
providing, by the one or more computers, a response to the user prompt from the chatbot, wherein the response from the chatbot comprises text generated by one or more artificial intelligence and/or machine learning (AI/ML) models using values from the data set.

17. The system of claim 16, wherein receiving the data indicating the user input comprises receiving a user indication to create the chatbot based on the data set or a document that references the data set, wherein the data set or the document has a corresponding group of settings; and
wherein creating the chatbot comprises creating configuration data for the chatbot to apply the group of settings to the chatbot based on the user indication and based on the group of settings being associated with the data set or the document.

18. The system of claim 16, wherein the one or more computers store a set of parameters configured to apply generally to chatbots of an organization or group; and
wherein the operations comprise applying the set of parameters to multiple chatbots of the organization or group.

19. The system of claim 16, wherein the code segment or module is configured to insert a chatbot interface for the chatbot into at least one of a native application, a web page, a web application, a dashboard, or a document.

20. One or more non-transitory computer-readable media storing instructions that are operable, when executed by one or more computers, to cause the one or more computers to perform operations comprising:
receiving, by the one or more computers, data indicating user input instructing a chatbot to be created and an indication of a data set for the chatbot to use;
creating, by the one or more computers, the chatbot based on data objects in the data set, wherein the chatbot is configured to respond to user prompts based on data objects in the data set;
providing, by the one or more computers, a code segment or module configured to cause a chatbot interface for interacting with the chatbot to be embedded in a user interface;
receiving, by the one or more computers, a user prompt provided for the chatbot through the user interface; and
providing, by the one or more computers, a response to the user prompt from the chatbot, wherein the response from the chatbot comprises text generated by one or more artificial intelligence and/or machine learning (AI/ML) models using values from the data set.
